(19) United States
(12) Patent Application Publication
(10) Pub. No.: US 2021/0388517 A1
(43) Pub. Date: Dec. 16, 2021

(54) ELECTROLYTIC REACTOR AND METHOD OF OPERATING SAME

(71) Applicant: dynaCERT Inc., Toronto (CA)

(72) Inventors: Bheepinderpreet Dhillon, Palgrave (CA); Gurjant Singh, Pickering (CA)

(21) Appl. No.: 17/281,613

(22) PCT Filed: Oct. 4, 2019
(86) PCT No.: PCT/CA2019/051427

§ 371 Date: Mar. 31, 2021

Related U.S. Application Data
(60) Provisional application No. 62/741,637, filed on Oct. 5, 2018.

(51) Int. Cl. C25B 15/027; C25B 9/73; C25B 9/65; C25B 1/04; F02M 25/12; F02M 21/02; F02M 21/06

(52) U.S. Cl. CPC C25B 15/027; C25B 9/73; C25B 9/65; F02M 21/06; F02M 25/12; F02M 21/0209; C25B 1/04

(57) ABSTRACT

The various embodiments disclosed herein relate to a system and a method of modifying a configuration of an electrolytic reactor. In at least one embodiment, the system comprises an electrolytic reactor assembly including a plurality of electrolytic cells, the electrolytic reactor assembly being configured to operate in at least two operation modes. The system also comprises at least one switching element coupled to the electrolytic reactor assembly, a control unit, and a monitoring system coupled to the control unit, where the monitoring system is configured to monitor at least one attribute associated with the electrolytic reactor assembly. The control unit is configured to modify the configuration of the electrolytic reactor assembly between the at least two operation modes based on the at least one attribute associated with the electrolytic reactor assembly monitored by the monitoring system.

### CROSS REFERENCE TO RELATED APPLICATIONS

This application claims priority from co-pending U.S. Provisional Patent Application No. 62/741,637, filed on Oct. 5, 2018, which is herein incorporated by reference in its entirety.

### FIELD

The described embodiments relate to an electrolytic reactor system, and in particular, to an electrolytic reactor system that is dynamically configurable to operate in temperatures that are below the optimum range of operation associated with the electrolytic reactor system.

### BACKGROUND

The fuel economy of an internal combustion engine may be improved by injecting hydrogen and oxygen gases into the engine's air-intake stream. In some cases, hydrogen and oxygen gases may be supplied to the internal combustion engine by an “on-demand” electrolytic reactor system, which electrolytically disassociates a substrate to generate hydrogen gas and oxygen gas.

Electrolytic reactor systems generally require an optimum temperature range in order to operate effectively. Electrolytic reactor systems operating in ambient temperatures below the optimum temperature range, i.e., in colder weather, may require an external heat source to initiate the electrolysis process.

The use of external heat sources, however, presents a number of challenges. In particular, external heat sources are usually located over, or within, knockout tanks that supply an electrolytic reactor with electrolyte solution. Accordingly, the electrolytic reactor does not receive direct heat from the external heat source, and as a result, takes longer durations of time to warm-up to a state of functional operation. In addition, external heat sources may demand additional input power to generate heat, separate from the power demands of the electrolytic reactor. There are also a number of potential safety hazards associated with the use of external heat sources with electrolytic reactors.

### SUMMARY

In one aspect of the invention, in at least one embodiment described herein, there is a method of modifying a configuration of an electrolytic reactor. The electrolytic reactor comprises an electrolytic reactor assembly including a plurality of electrolytic cells where the electrolytic reactor assembly is configured to perform electrolysis on an electrolyte solution, and operate in at least two operation modes. The method comprises determining, by a monitoring system, at least one attribute associated with electrolytic reactor assembly; analyzing, by a control unit coupled to the monitoring system, the at least one attribute; determining, by the control unit, an operation mode associated with the electrolytic reactor assembly based on the at least one attribute; and modifying, by at least one switching element, the configuration of the electrolytic reactor to the operation mode determined by the control unit.

In a feature of that aspect, the method further comprises coupling a first switching element to a first predetermined number of electrolytic cells in the electrolytic reactor assembly; coupling a second switching element to a second predetermined number of electrolytic cells in the electrolytic reactor assembly, the second predetermined number of electrolytic cells being fewer than the first predetermined number of electrolytic cells; coupling a third switching element to a third predetermined number of electrolytic cells in the electrolytic reactor assembly, the third predetermined number of electrolytic cells being fewer than the second predetermined number of electrolytic cells; and coupling a fourth switching element to a fourth predetermined number of electrolytic cells in the electrolytic reactor assembly, the fourth predetermined number of electrolytic cells being fewer than the third predetermined number of electrolytic cells.

In another feature, the method further comprises operating the electrolytic reactor assembly in a first operation mode by activating the first switching element if a first signal from the monitoring system identifies a first predetermined temperature range associated with the electrolytic reactor assembly.

In yet another feature, the method further comprises operating the electrolytic reactor assembly in a first operation mode by activating the first switching element if a first signal from the monitoring system identifies a first predetermined range of current consumption associated with the electrolytic reactor assembly.

In a further feature, the method further comprises operating the electrolytic reactor assembly in a second operation mode by activating the second switching element if a second signal from the monitoring system identifies a second predetermined temperature range associated with the electrolytic reactor assembly, the second predetermined temperature range being lower than the first predetermined temperature range.

In another feature, the method further comprises operating the electrolytic reactor assembly in a second operation mode by activating the second switching element if a second signal from the monitoring system identifies a second predetermined current consumption range associated with the electrolytic reactor assembly, the second predetermined current consumption range being lower than the first predetermined current consumption range.

In yet another feature, operating the electrolytic reactor assembly in the second operation mode results in the electrolytic reactor system generating more heat than operating the electrolytic reactor assembly in the first operation mode.

In a further feature, the method further comprises operating the electrolytic reactor assembly in a third operation mode by activating the third switching element if a third signal from the monitoring system identifies a third predetermined temperature range associated with the electrolytic reactor assembly, the third predetermined temperature range being lower than the second predetermined temperature range.

In another feature, the method further comprises operating the electrolytic reactor assembly in a third operation mode by activating the third switching element if a third signal from the monitoring system identifies a third predetermined current consumption range associated with the electrolytic reactor assembly, the third predetermined current consumption range being lower than the second predetermined current consumption range.

In yet another feature, operating the electrolytic reactor assembly in the third operation mode results in the electrolytic reactor system generating more heat than operating the electrolytic reactor assembly in either the first operation mode or the second operation mode.

In a further feature, the method further comprises operating the electrolytic reactor assembly in a fourth operation mode by activating the fourth switching element if a fourth signal from the monitoring system identifies the third predetermined temperature range associated with the electrolytic reactor assembly.

In another feature, the method further comprises operating the electrolytic reactor assembly in a fourth operation mode by activating the fourth switching element if a fourth signal from the monitoring system identifies the third predetermined current consumption range associated with the electrolytic reactor assembly.

In yet another feature, operating the electrolytic reactor assembly in the fourth operation mode results in the electrolytic reactor system generating more heat than operating the electrolytic reactor assembly in either the first operation mode, the second operation mode or the third mode of operation.

In a further feature, the electrolytic reactor is coupled to an internal combustion engine, and the electrolyte solution used in the electrolytic reactor is water, and the method further comprises detecting one or more operating conditions associated with an internal combustion engine, wherein the internal combustion engine is configured to combust a mixture of a carbon-based fuel, hydrogen gas and oxygen gas; determining, at the control unit, if the internal combustion engine requires a higher amount of hydrogen gas; and activating at least one of the second switching element, the third switching element and the fourth switching element if a higher amount of the hydrogen gas is required by the internal combustion engine.

In another aspect, in at least one embodiment described herein, there is a system for modifying a configuration of an electrolytic reactor, where the system comprises an electrolytic reactor assembly including a plurality of electrolytic cells, the plurality of electrolytic cells being configured to perform electrolysis on an electrolyte solution, and the electrolytic reactor assembly being configured to operate in at least two operation modes, at least one switching element coupled to the electrolytic reactor assembly, a control unit operatively coupled to the at least one switching element and the electrolytic reactor assembly; and a monitoring system coupled to the control unit, the electrolytic reactor assembly and the at least one switching element, wherein the monitoring system is configured to monitor at least one attribute associated with the electrolytic reactor assembly, wherein the control unit is configured to modify the configuration of the electrolytic reactor assembly between the at least two operation modes based on the at least one attribute of the electrolytic reactor assembly monitored by the monitoring system.

In a feature of that aspect, the monitoring system comprises a temperature sensor configured to monitor an ambient temperature associated with the electrolytic reactor assembly, where the control unit is configured to modify the configuration of the electrolytic reactor assembly based on the ambient temperature.

In another feature, the temperature sensor is located proximate to the electrolytic reactor assembly.

In a further feature, the monitoring system comprises a current sensor configured to monitor a current consumption by the electrolytic reactor assembly, where the control unit is configured to modify the configuration of the electrolytic reactor assembly based on the current consumption by the electrolytic reactor assembly.

In yet another feature, a gas production rate of the electrolytic reactor assembly is determined based on the current consumption of the electrolytic reactor assembly.

In another feature, the plurality of electrolytic cells are divided between a first cell unit and a second cell unit, wherein the first cell unit and the second cell unit are arranged in parallel relative to each other, and wherein the electrolytic cells within each of the first cell unit and the second cell unit are arranged in series relative to each other.

In yet another feature, the first cell unit and the second cell unit share a common negative.

In a further feature, each of the first and second cell units comprise six electrolytic cells.

In another feature, the at least one switching element comprises a first switching element coupled to six electrolytic cells in the first cell unit, and six electrolytic cells in the second cell unit, a second switching element coupled to five electrolytic cells in the first cell unit, and five electrolytic cells in the second cell unit, a third switching element coupled to four electrolytic cells in the first cell unit, and four electrolytic cells in the second cell unit, and a fourth switching element coupled to three electrolytic cells in the first cell unit, and three electrolytic cells in the second cell unit.

In yet another feature, the control unit is configured to operate the electrolytic reactor assembly in a first operation mode by activating the first switching element based on a first signal from the monitoring system, the first signal indicating that the ambient temperature is within a first predetermined temperature range.

In another feature, the control unit is configured to operate the electrolytic reactor assembly in a first operation mode by activating the first switching element based on a first signal from the monitoring system, the first signal indicating that the current consumption of the electrolytic reactor assembly is within a first predetermined current consumption range.

In yet another feature, the control unit is configured to operate the electrolytic reactor assembly in a second operation mode by activating the second switching element based on a second signal from the monitoring system, the second signal indicating that the ambient temperature is within a second predetermined temperature range, the second predetermined temperature range being lower than the first predetermined temperature range.

In another feature, the control unit is configured to operate the electrolytic reactor assembly in a second operation mode by activating the second switching element based on a second signal from the monitoring system, the second signal indicating that the current consumption of the electrolytic reactor assembly is within a second predetermined current consumption range, the second predetermined current consumption range being lower than the first predetermined current consumption range.

In a further feature, operating the electrolytic reactor assembly in the second operation mode results in the electrolytic reactor system generating more heat than operating the electrolytic reactor assembly in the first operation mode.

In another feature, the control unit is configured to operate the electrolytic reactor assembly in a third operation mode by activating the third switching element based on a third signal from the monitoring system, the third signal indicating that the ambient temperature is within an a third predetermined temperature range, the third predetermined temperature range being lower than the second predetermined temperature range.

In yet another feature, the control unit is configured to operate the electrolytic reactor assembly in a third operation mode by activating the third switching element based on a third signal from the monitoring system, the third signal indicating that the current consumption of the electrolytic reactor assembly is within a third predetermined current consumption range, the third predetermined current consumption range being lower than the second predetermined current consumption range.

In a further feature, operating the electrolytic reactor assembly in the third operation mode results in the electrolytic reactor system generating more heat than operating the electrolytic reactor assembly in either the first operation mode or the second operation mode.

In another feature, the control unit is configured to operate the electrolytic reactor assembly in a fourth operation mode by activating the fourth switching element based on a fourth signal from the monitoring system, the fourth signal indicating that the ambient temperature is within the third predetermined temperature range.

In a further feature, the control unit is configured to operate the electrolytic reactor assembly in a fourth operation mode by activating the fourth switching element based on a fourth signal from the monitoring system, the fourth signal indicating that the current consumption of the electrolytic reactor assembly is within the third predetermined current consumption range.

In yet another feature, operating the electrolytic reactor assembly in the fourth operation mode results in the electrolytic reactor system generating more heat than operating the electrolytic reactor assembly in either the first operation mode, the second operation mode, or the third mode of operation.

In another feature, the monitoring system is further configured to monitor one or more operating conditions of an internal combustion engine, and the control unit is configured to control the at least one switching element based at least on the one or more operating conditions of the internal combustion engine.

In another aspect, in at least one embodiment described herein, there is provided a computer-readable medium storing computer-executable instructions, the instructions are executable for causing a processor to perform a method of modifying a configuration of an electrolytic reactor, the electrolytic reactor comprising an electrolytic reactor assembly including a plurality of electrolytic cells where the electrolytic reactor assembly is configured to perform electrolysis on an electrolyte solution, and operate in at least two operation modes. The method comprises determining, by a monitoring system, at least one attribute associated with electrolytic reactor assembly; analyzing, by a control unit coupled to the monitoring system, the at least one attribute determined by the monitoring system; determining, by the control unit, an operation mode associated with the electrolytic reactor assembly based on the at least one attribute; and modifying, by at least one switching element, the configuration of the electrolytic reactor to the operation mode determined by the control unit.

In a feature of that aspect, the instructions stored in the computer-readable medium are executable to cause the processor to perform the method further comprising at least one of: coupling a first switching element to a first predetermined number of electrolytic cells in the electrolytic reactor assembly; coupling a second switching element to a second predetermined number of electrolytic cells in the electrolytic reactor assembly, the second predetermined number of electrolytic cells being fewer than the first predetermined number of electrolytic cells; coupling a third switching element to a third predetermined number of electrolytic cells in the electrolytic reactor assembly, the third predetermined number of electrolytic cells being fewer than the second predetermined number of electrolytic cells; and coupling a fourth switching element to a fourth predetermined number of electrolytic cells in the electrolytic reactor assembly, the fourth predetermined number of electrolytic cells being fewer than the third predetermined number of electrolytic cells.

In another feature, the instructions stored in the computer-readable medium are executable to cause the processor to perform the method further comprising operating the electrolytic reactor assembly in a first operation mode by activating the first switching element if a first signal from the monitoring system identifies a first predetermined temperature range associated with the electrolytic reactor assembly.

In a further feature, the instructions stored in the computer-readable medium are executable to cause the processor to perform the method further comprising: operating the electrolytic reactor assembly in a first operation mode by activating the first switching element if a first signal from the monitoring system identifies a first predetermined range of current consumption associated with the electrolytic reactor assembly.

In yet another feature, the instructions stored in the computer-readable medium are executable to cause the processor to perform the method further comprising: operating the electrolytic reactor assembly in a second operation mode by activating the second switching element if a second signal from the monitoring system identifies a second predetermined temperature range associated with the electrolytic reactor assembly, the second predetermined temperature range being lower than the first predetermined temperature range.

In a further feature, the instructions stored in the computer-readable medium are executable to cause the processor to perform the method further comprising: operating the electrolytic reactor assembly in a second operation mode by activating the second switching element if a second signal from the monitoring system identifies a second predetermined current consumption range associated with the electrolytic reactor assembly, the second predetermined current consumption range being lower than the first predetermined current consumption range.

In another feature, operating the electrolytic reactor assembly in the second operation mode results in the electrolytic reactor system generating more heat than operating the electrolytic reactor assembly in the first operation mode.

In yet another feature, the instructions stored in the computer-readable medium are executable to cause the processor to perform the method further comprising: operating the electrolytic reactor assembly in a third operation mode by activating the third switching element if a third signal from the monitoring system identifies a third predetermined temperature range associated with the electrolytic reactor assembly, the third predetermined temperature range being lower than the second predetermined temperature range.

In a further feature, the instructions stored in the computer-readable medium are executable to cause the processor to perform the method further comprising: operating the electrolytic reactor assembly in a third operation mode by activating the third switching element if a third signal from the monitoring system identifies a third predetermined current consumption range associated with the electrolytic reactor assembly, the third predetermined current consumption range being lower than the second predetermined current consumption range.

In another feature, operating the electrolytic reactor assembly in the third operation mode results in the electrolytic reactor system generating more heat than operating the electrolytic reactor assembly in either the first operation mode or the second operation mode.

In yet another feature, the instructions stored in the computer-readable medium are executable to cause the processor to perform the method further comprising operating the electrolytic reactor assembly in a fourth operation mode by activating the fourth switching element if a fourth signal from the monitoring system identifies the third predetermined temperature range associated with the electrolytic reactor assembly.

In a further feature, the instructions stored in the computer-readable medium are executable to cause the processor to perform the method further comprising operating the electrolytic reactor assembly in a fourth operation mode by activating the fourth switching element if a fourth signal from the monitoring system identifies the third predetermined current consumption range associated with the electrolytic reactor assembly.

In another feature, operating the electrolytic reactor assembly in the fourth operation mode results in the electrolytic reactor system generating more heat than operating the electrolytic reactor assembly in either the first operation mode, the second operation mode or the third mode of operation.

In yet another feature, the electrolytic reactor is coupled to an internal combustion engine, and the electrolyte solution used in the electrolytic reactor is water, and wherein stored in the computer-readable medium are executable to cause the processor to perform the method further comprising: detecting one or more operating conditions associated with an internal combustion engine, wherein the internal combustion engine is configured to combust a mixture of a carbon-based fuel, hydrogen gas and oxygen gas; determining, at the control unit, if the internal combustion engine requires a higher amount of hydrogen gas; and activating at least one of the second switching element, the third switching element and the fourth switch element if a higher amount of the hydrogen gas is required by the internal combustion engine.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from the detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1A is an image of a wrap heater according to an example embodiment;

FIG. 1B is an image of a filament heater according to another example embodiment;

FIG. 1C is an image of an insulation wrap according to still a further example embodiment;

FIG. 2A is an example of a block diagram of a fuel management system;

FIG. 2B is another example of a block diagram of the fuel management system;

FIG. 3A is an example of a block diagram of an electrolytic reactor system;

FIG. 3B is an example of a block diagram of a reactor system;

FIG. 3C is a simplified block diagram of the reactor system of FIG. 3B;

FIG. 4A is an example of a schematic representation of the reactor system of FIG. 3B;

FIG. 4B is another example of a schematic representation of the reactor system of FIG. 3B;

FIG. 4C is a further example of a schematic representations of the reactor system of FIG. 3B;

FIG. 4D is still a further example of a schematic representation of the reactor system of FIG. 3B;

FIG. 5A is an example of a schematic perspective view of a reactor cell and tank system assembly;

FIG. 5B is another example of a schematic perspective view of a reactor cell and tank system assembly;

FIG. 5C is an example perspective view of a float switch in an un-triggered state;

FIG. 5D is another example perspective view of a float switch of FIG. 5C in a triggered state;

FIG. 6A is a schematic perspective view of another example of a reactor cell and tank system assembly;

FIG. 6B is a schematic perspective view of a further example of a reactor cell and tank system assembly;

FIG. 6C is a schematic perspective view of still a further example of a reactor cell and tank system assembly;

FIG. 6D is a schematic top perspective view of a container in a reactor and tank assembly, according to some embodiments;

FIG. 6E is a perspective view of example gas connectors;

FIG. 6F is a perspective view of example gas tubes;

FIG. 7 is a perspective view of an example electrolytic reactor system;

FIG. 8 is an example of a method for modifying a configuration of a reactor system;

FIG. 9 is another example of a method for modifying a configuration of a reactor system;

FIG. 10A is a method for modifying a configuration of a reactor system according to one example; and

FIG. 10B is another method for modifying a configuration of a reactor system according to another example.

The skilled person in the art will understand that the drawings, described below, are for illustration purposes only. The drawings are not intended to limit the scope of the applicants' teachings in anyway. In addition, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Various apparatuses or processes will be described below to provide an example of at least one embodiment of the claimed subject matter. No embodiment described below limits any claimed subject matter and any claimed subject matter may cover processes, apparatuses, devices or systems that differ from those described below. The claimed subject matter is not limited to apparatuses, devices, systems or processes having all of the features of any one apparatus, device, system or process described below or to features common to multiple or all of the apparatuses, devices, systems or processes described below. It is possible that an apparatus, device, system or process described below is not an embodiment of any claimed subject matter. Any subject matter that is disclosed in an apparatus, device, system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. In addition, the description is not to be considered as limiting the scope of the example embodiments described herein.

It should also be noted that the terms “coupled” or “coupling” as used herein can have several different meanings depending in the context in which the term is used. For example, the term coupling can have a mechanical or electrical connotation. For example, as used herein, the terms “coupled” or “coupling” can indicate that two elements or devices can be directly connected to one another or connected to one another through one or more intermediate elements or devices via an electrical element, electrical signal or a mechanical element such as but not limited to, a wire or a cable, for example, depending on the particular context.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

The various embodiments of the devices, systems and methods described herein may be implemented using a combination of hardware and software. These embodiments may be implemented in part using computer programs executing on programmable devices, each programmable device including at least one processor, an operating system, one or more data stores (including volatile memory or non-volatile memory or other data storage elements or a combination thereof), at least one communication interface and any other associated hardware and software that is necessary to implement the functionality of at least one of the embodiments described herein. For example, and without limitation, the computing device may be a server, a network appliance, an embedded device, a computer expansion module, a personal computer, a laptop, a personal data assistant, a cellular telephone, a smart-phone device, a tablet computer, a wireless device or any other computing device capable of being configured to carry out the methods described herein. The particular embodiment depends on the application of the computing device.

In some embodiments, the communication interface may be a network communication interface, a USB connection or another suitable connection as is known by those skilled in the art. In other embodiments, the communication interface may be a software communication interface, such as those for inter-process communication (IPC). In still other embodiments, there may be a combination of communication interfaces implemented as hardware, software, and a combination thereof.

In at least some of the embodiments described herein, program code may be applied to input data to perform at least some of the functions described herein and to generate output information. The output information may be applied to one or more output devices, for display or for further processing.

At least some of the embodiments described herein that use programs may be implemented in a high level procedural or object oriented programming and/or scripting language or both. Accordingly, the program code may be written in C, Java, SQL or any other suitable programming language and may comprise modules or classes, as is known to those skilled in object-oriented programming. However, other programs may be implemented in assembly, machine language or firmware as needed. In either case, the language may be a compiled or interpreted language.

The computer programs may be stored on a storage media (e.g. a computer readable medium such as, but not limited to, ROM, magnetic disk, optical disc) or a device that is readable by a general or special purpose computing device. The program code, when read by the computing device, configures the computing device to operate in a new, specific and predefined manner in order to perform at least one of the methods described herein.

Furthermore, some of the programs associated with the system, processes and methods of the embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

Electrolytic reactor systems that supply internal combustion engines with hydrogen and oxygen gases generally require an optimum temperature range in order to operate effectively. Electrolytic reactor systems operating in ambient temperatures below the optimum temperature range, i.e., in colder weather, may require an external heat source to start the electrolysis process.

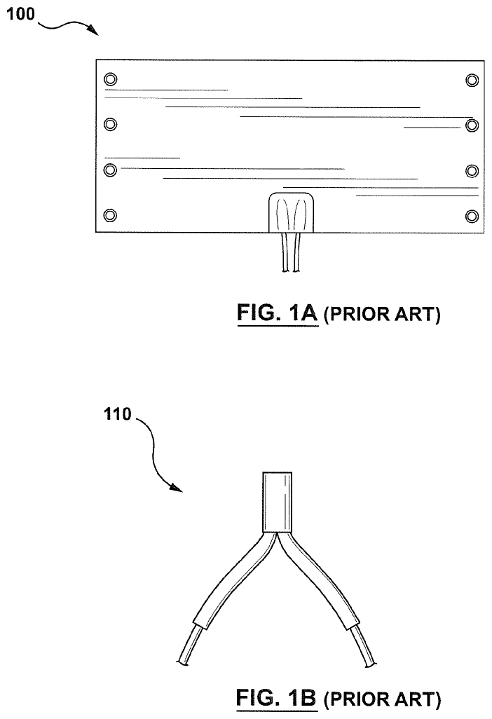

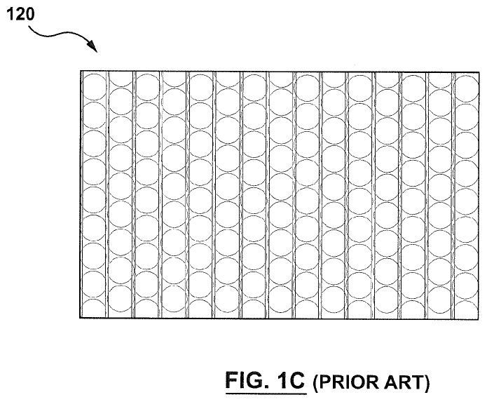

Examples of conventional external heat sources used with electrolytic reactor systems are shown in FIGS. 1A-1C. FIG. 1A is an image of a wrap heater 100 which may be wrapped around knockout tanks that supply electrolyte solution to an electrolytic reactor. FIG. 1B is an image of a filament heater 110 that may be suspended inside the knockout tanks. FIG. 1C is an image of an insulating wrap 120 which may be also wrapped around the knockout tanks to preserve heat.

The use of external heat sources, however, presents a number of challenges. In particular, as external heat sources are typically placed over, or within, knockout tanks, which are removed from the electrolytic cells or electrodes carrying out the electrolysis process, the electrodes and the electrolyte solution do not receive direct heat from the external heat source. Accordingly, the electrodes and the electrolyte solution take a long time to warm-up to a state of functional operation. Furthermore, heat generated by external heat sources is often lost to the environment and is not directly transferred to the electrolyte solution in the electrolytic reactor.

External heat sources also demand additional input power to generate heat, separate from the power demands of the electrolytic reactor. For example, the wrap heater 100 of FIG. 1A and filament heater 110 of FIG. 1B may require a 12V source having a power rating of 40 W in order to generate heat. Installing the external heat sources, and connecting the heat source to a power supply, can also be a time-consuming and expensive process.

Finally, potential safety hazards may result from using external heat sources with electrolytic reactors. For example, wrap around heaters, such as wrap heater 100 of FIG. 1A, may cause melting of the knockout tanks, and leakage of highly corrosive electrolyte solution. The filament heater 110 of FIG. 1B is also prone to igniting hydrogen gas, which may be generated as a byproduct of electrolysis, inside of the knockout tanks.

In various embodiments discussed herein, systems and methods are provided for an improved electrolytic reactor which can efficiently operate without a need for an external heat source. In particular, the improved electrolytic reactor disclosed herein is configured to operate in cold temperatures, i.e. temperatures below the optimum temperature range of the electrolytic reactor, by modifying its configuration. As discussed in detail below, in some embodiments, the improved electrolytic reactor is configured to reduce the number of active electrolytic cells or electrodes involved in the process of electrolysis. By reducing the number of active cells in the electrolytic reactor, the same input voltage is divided among fewer cells, resulting in increased current per cell, and accordingly, higher gas production from electrolysis. The increased gas production in turn warms up the reactor to its optimum temperature range. As a result, the electrolytic reactor system provided herein is able to warm-up to a state of functional operation shortly after being activated.

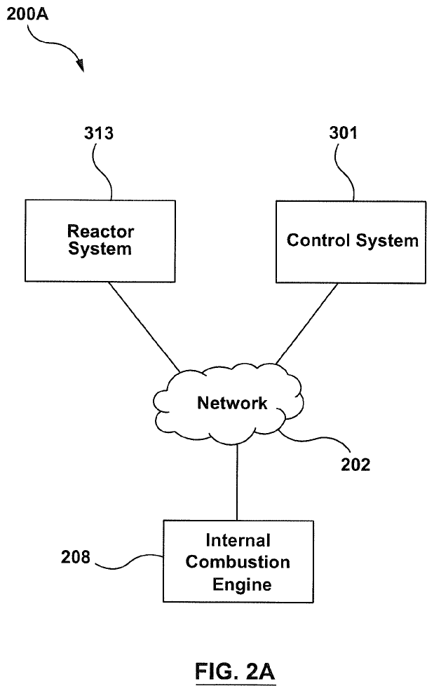

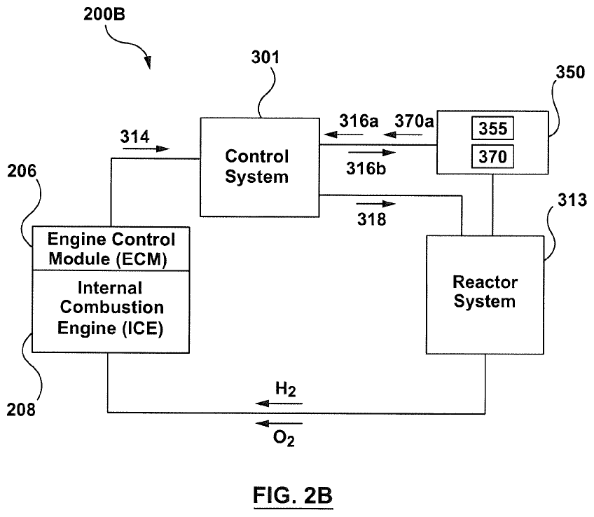

Reference is briefly made to both FIGS. 2A and 2B, each of which illustrate example applications of a reactor system disclosed herein. In particular, FIG. 2A illustrates a block diagram of a fuel management system 200A according to one example. FIG. 2B illustrates a block diagram of a fuel management system 200B according to another example.

The fuel management system 200A of FIG. 2A and 200B of FIG. 2B illustrate a reactor system 313, which is used to improve the fuel economy of an internal combustion engine (ICE) 208. In particular, the reactor system 313 is configured to carry out the process of electrolysis in which it supplies an air-intake stream of the internal combustion engine 208 with hydrogen (H₂) and oxygen (O₂) gases.

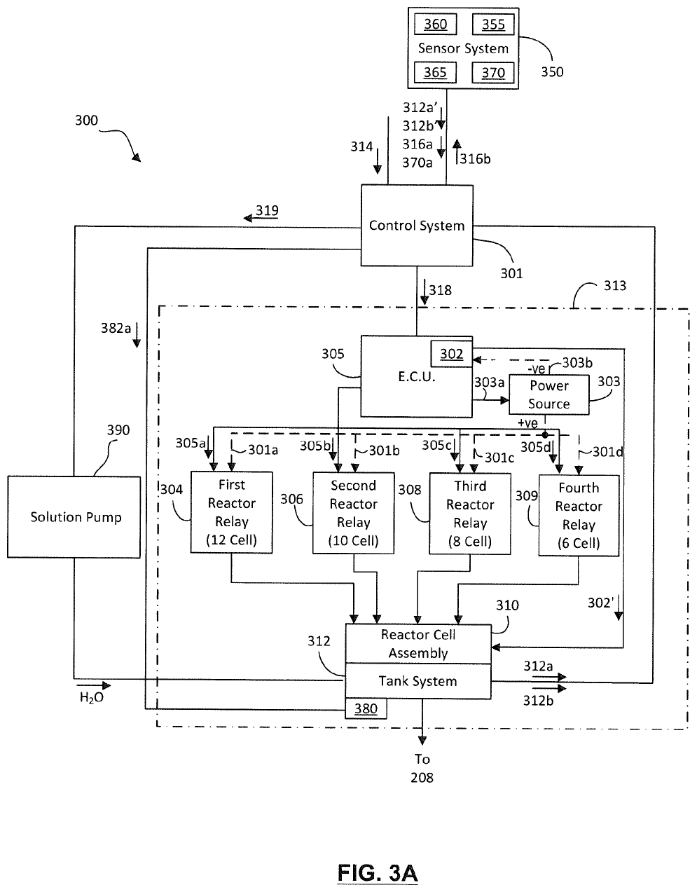

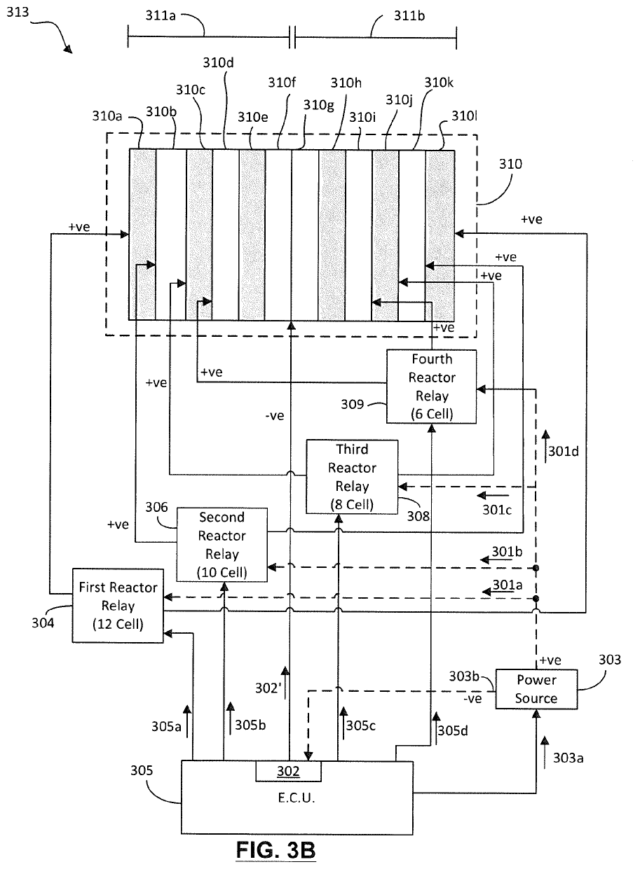

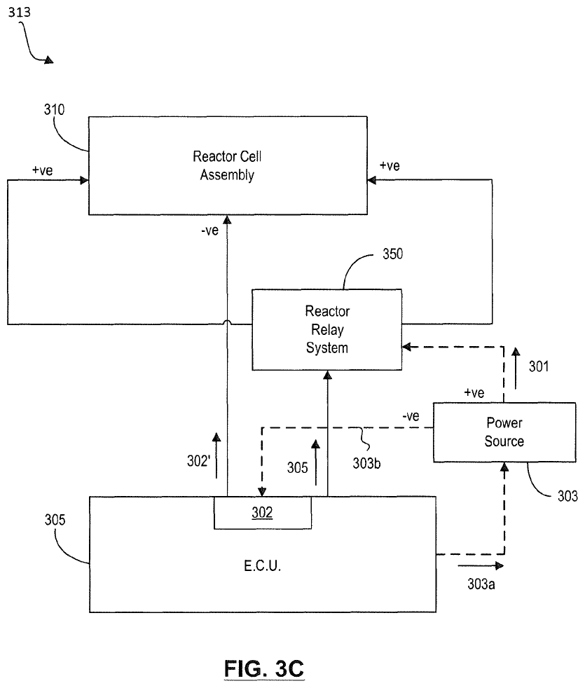

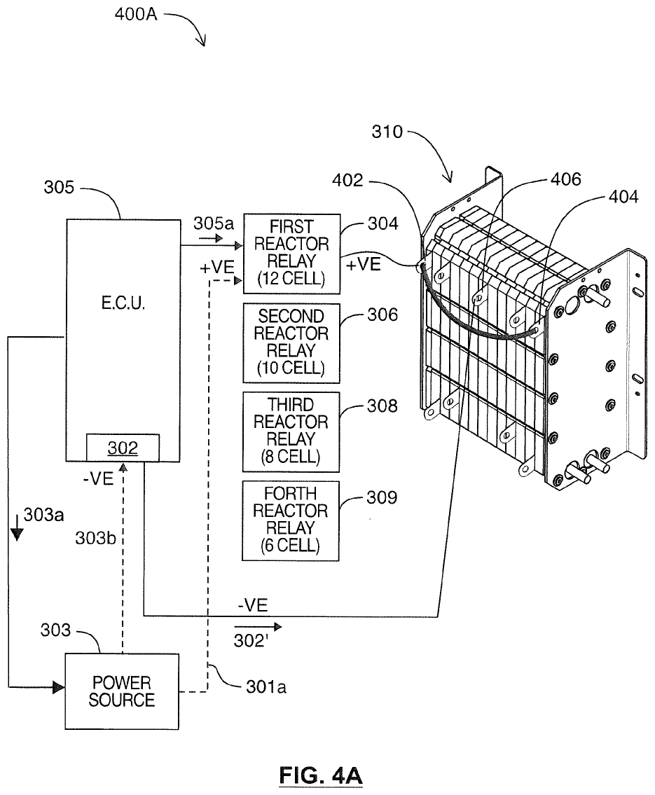

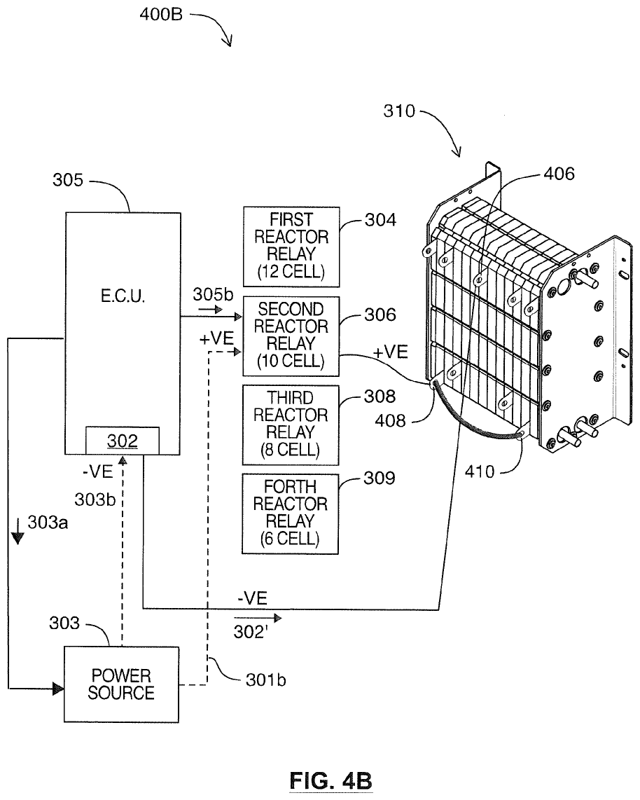

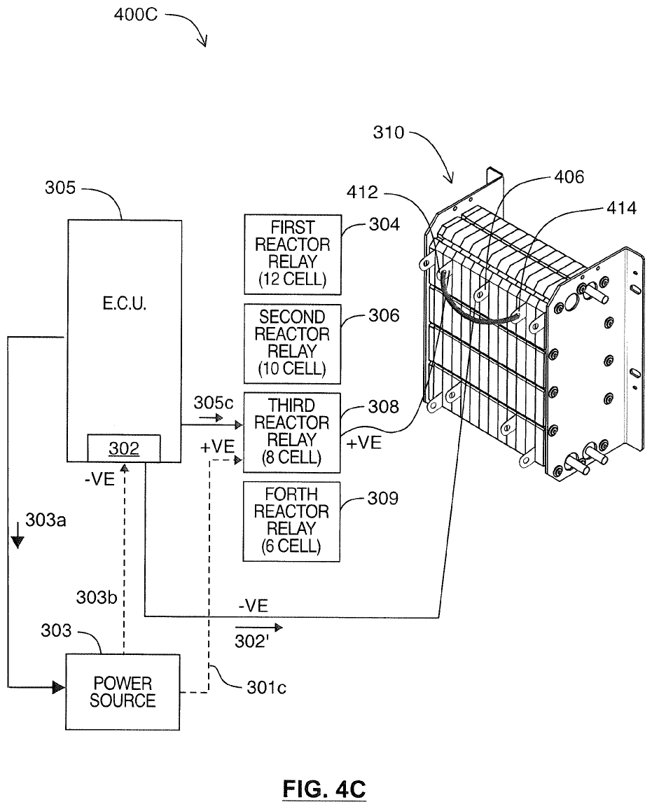

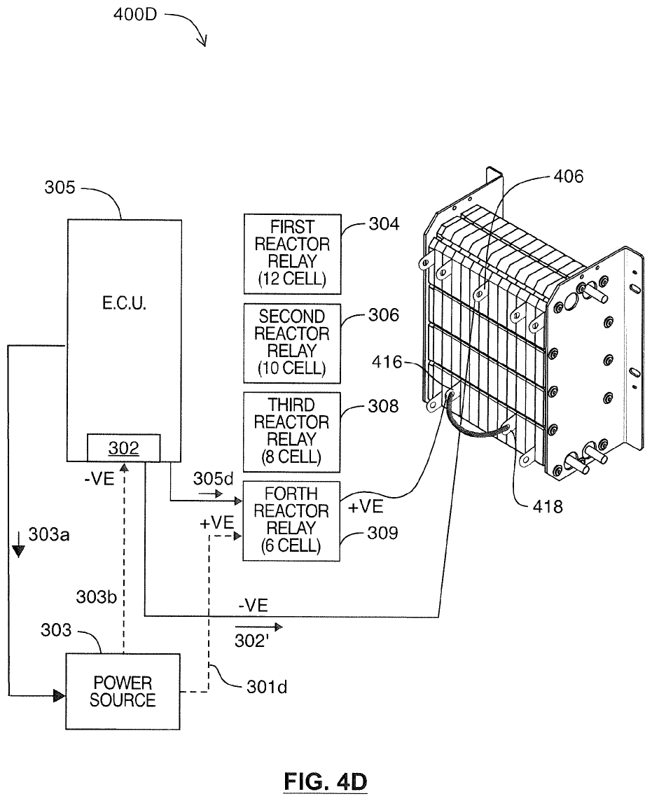

In the embodiments illustrated in FIGS. 2A and 2B, the configuration, and accordingly the operation, of the reactor system 313 is modified based on certain attributes associated with the reactor system 313. Some non-limiting examples of such attributes may include the ambient temperature associated with the reactor system 313, the current consumption associated with the reactor system 313, the amount of gas generated in the reactor system 313, the amount of heat generated in the reactor system, etc. This is discussed in detail below, especially with reference to FIGS. 3A-3C and 4A-4D.

In the various embodiments discussed below, the configuration of the reactor system 313 is modified by increasing or decreasing the number of active electrolytic cells within the reactor system 313. As discussed in detail below, by manipulating the number of active electrolytic cells in the rector system 313, the amount of gas production and the amount of heat generated may be controlled.

Reference is made to FIG. 3A, which illustrates an electrolytic reactor platform 300 according to an example embodiment. The electrolytic reactor platform 300 includes a solution pump 390, the reactor system 313, and a control system 301.

The solution pump 390 is configured to provide electrolyte solution to the reactor system 313 for electrolysis. In some cases, the solution pump 390 is coupled to a source of pure water or substantially pure water (e.g., distilled water).

The reactor system 313 includes a reactor cell assembly 310. The reactor cell assembly 310 includes numerous electrolytic cells connected to each other that are configured to carry out the process of electrolysis. The reactor cell assembly 310 receives electrolyte solution from a tank system 312, which is in fluid connection with the solution pump 390.

In some cases, where the electrolyte solution is water, the reactor cell assembly 310 is configured to receive a combination of water and potassium hydroxide (KOH). In some other cases, where the electrolyte solution is water, the reactor cell assembly 310 is configured to receive the water and the KOH separately, and combine them after being received. In the latter case, the reactor cell assembly 310 is coupled to a source of KOH.

The KOH is typically used in the electrolysis of water as it provides the water with free ions in order to enhance the conductivity of the water, and by extension, facilitates the process of electrolysis. In some cases, the solution inside of the reactor cell assembly 310 includes a mixture of 55% water and 45% KOH. In such cases, the reactor system 313 may be required to operate in temperatures under 65 degree Celsius to ensure that corrosive KOH vapors are not generated, and accordingly do not exit the reactor system 313. This is particularly important where the reactor system 313 is used in conjunction with an ICE since the ICE may be otherwise corroded by the KOH vapors. The reactor system 313 may also be required to operate in temperatures above negative 28 degrees Celsius. In particular, KOH reaches its freezing point in temperatures below negative 28 degrees Celsius, which can render the reactor system 313 non-operational.

While carrying out the electrolysis process, the reactor cell assembly 310 generates byproducts, corresponding to the electrolyte solution, in gaseous form. In cases where the electrolyte solution is water, the reactor cell assembly 310 is configured to generate hydrogen and oxygen gases as byproducts of electrolysis. The byproducts are then channeled back into the tank system 312, and directed to the appropriate systems based on the application of the reactor system 313. In cases where the reactor system 313 is used in application with an internal combustion engine to improve the fuel economy of the engine, the gaseous byproducts of the reactor system are directed to the ICE. This application of the reactor system 313 is discussed with reference to FIGS. 2A and 2B in detail below.

As illustrated in FIG. 3A, the control system 301, as described in further detail below, is coupled to a monitoring system 350. Monitoring system 350 may include one or more units, devices and/or systems that are capable of monitoring one or more parameters associated with one or more components of the electrolytic reactor platform 300. For example, monitoring system 350 may include one or more sensors capable of monitoring temperature associated with the reactor system 313. In some other cases, the monitoring system 350 may include one or more sensors capable of monitoring pressure associated with the reactor system 313. In another example, the monitoring system 350 may include one or more sensors capable of measuring the current consumption of the reactor system 313.

In one embodiment, the monitoring system 350 includes a temperature sensor 355 configured to monitor the ambient temperature of the reactor system 313. Even though the temperature sensor 355 is shown to be located remotely from the reactor system 313, the temperature sensor 355 can be located anywhere in association with the reactor system 313 so that it can measure the ambient temperature of the reactor system 313. For example, in some cases, the temperature sensor 355 is located inside the reactor system 313. In some other cases, the temperature sensor 355 is located inside the reactor cell assembly 310. In some further cases, the temperature sensor 355 is located adjacent to the tank system 312. As can be appreciated, the various locations of the temperature sensor 355 disclosed herein are intended to be non-limiting examples only.

In this embodiment, the temperature sensors 355 are configured to transmit temperature measurements to the control system 301 through temperature signals 316a. The control system 301 uses the information contained in the temperature signals 316a to make determinations with respect to the operation of the reactor system 313. For example, the control system 301 may determine from the temperature signals 316a that the reactor system 313 is operating in temperatures below the ideal operating temperature range. Accordingly, the control system 301 may transmit a control signal 318 instructing the reactor system 313 to vary a configuration of the reactor cell assembly 310 with a view to heating the reactor system 313 to within the ideal operating temperature range.

In another embodiment, the monitoring system 350 can include current sensors 370 that are configured to monitor the current consumption of the reactor system 313. For example, the current sensors 370 may include ammeters or other suitable current sensing devices. Similar to the temperature sensors 355, the current sensors 370 are configured to transmit current measurements to the control system 301 through current signals 370a. The control system 301 uses the information contained in the current signals 370a to make determinations with respect to the operation of the reactor system 313.

In at least some embodiments, information contained in the current signals 370a may be used by the control system 301 to determine the rate of gas produced by the reactor system 313. For example, high current consumption by the reactor system 313 may be correlated with higher rates of gas production, while low current consumption by the reactor system 313 may be correlated with lower rates of gas production. In cases where the electrolyte solution is water, the current consumption can be correlated to the gas production rate by determining the energy (e.g. current) required to split the water molecules into the hydrogen gas and oxygen gas byproducts.

In at least some example cases, the control system 301 may determine from the current signal 370a that the reactor system 313 is consuming high amounts of current and is accordingly producing gas at a rate that is above the ideal rate of gas production. In these cases, the control system 301 may transmit a control signal 318 instructing the reactor system 313 to vary a configuration of the reactor cell assembly 310 with a view to reducing both the current consumption of the reactor system 313, as well as the gas production rate of the reactor system 313.

In other embodiments, information contained in the current signals 370a may also be used by the control system 301 to determine the relative operating temperature of the reactor system 313. For example, at higher (e.g., warmer) operating temperatures, the gas production rate of the reactor system 313 is increased (i.e., the electrolysis process is catalyzed at higher temperatures), and by extension, the reactor system 313 consumes larger amounts of current to accommodate the higher gas production rate. Conversely, at lower (e.g., colder) operating temperatures, the gas production rate of the reactor system 313 is reduced (i.e., the electrolysis process is adversely affected at lower temperatures), and by extension, the reactor system 313 consumes lower amounts of current in response to the lower gas production rate. In this manner, the current consumption of the reactor system 313 may be correlated to the operating temperature of the reactor system 313.

To illustrate the relationship between current consumption and the operating temperature of the reactor system 313, Table 1 below provides example temperature and corresponding current consumption measurements for six monitored reactors. In Table 1, the voltages across the first three reactors (reactors 1 to 3) and the voltages across the last three reactors (reactors 4 to 6) are each maintained at a constant level. As observed, an increase in the temperature for each of the six reactors results in higher current consumption by each of the reactors:

TABLE 1
Example Temperature and Corresponding Current Consumption
Measurements for Different Monitored Reactors

| Reactor 1 | Reactor 2 | Reactor 3 | Reactor 4 | Reactor 5 | Reactor 6 |
|---|---|---|---|---|---|
| 20° C. | 22° C. | 22° C. | 19° C. | 27° C. | 26° C. |
| (6.9 A) | (8 A) | (8.2 A) | (9.8 A) | (13.7 A) | (10.3 A) |
| 30° C. | 33° C. | 32° C. | 24° C. | 42° C. | 34° C. |
| (8.1 A) | (10.3 A) | (10.2 A) | (10.5 A) | (19.5 A) | (11.9 A) |
| 35° C. | 39° C. | 38° C. | 41° C. | 41° C. | 33° C. |
| (9.4 A) | (11.2 A) | (11 A) | (15.3 A) | (17.2 A) | (9.7 A) |
| 37° C. | 40° C. | 39° C. | 41° C. | 41° C. | 34° C. |
| (9 A) | (11.5 A) | (11.2 A) | (15.1 A) | (17.8 A) | (11.3 A) |

Accordingly, and in at least some example cases, the control system 301 may determine from the current signal 370a that the reactor system 313 is operating in a temperature range that is below the ideal temperature range because the reactor system 313 is consuming low amounts of current. As a result, the control system 301 may transmit a control signal 318 instructing the reactor system 313 to vary a configuration of the reactor cell assembly 310 with a view to increasing the gas production rate of the reactor system 313, and by extension, increasing the current consumption and the operating temperature of the reactor system 313.

In some cases, the current sensor 370 may offer more reliable information than the temperature sensors 355. For example, based on the location of the temperature sensor 355 and factors, such as heat conductivity, associated with the reactor cell assembly 310, the temperature detected by the temperature sensors 355 may be skewed.

In some other cases, it may not be feasible to insert the temperature sensors 355 into the reactor system 313 (e.g., where the system is operating under high pressure). In such cases, the current sensor 370 may offer a more direct and reliable indication of the operating temperature of the reactor system 313 than information provided by the temperature sensor 355.

In applications where the reactor cell 313 supplies hydrogen and oxygen gases to the internal combustion engine, the operating conditions of the engine may be communicated to the control system 301 via an engine data signal 314 (e.g., FIG. 2B). The control system 301 may use information contained in the engine data signal 314 to make determinations with respect to the operation of the reactor system 313. For example, the control system 301 may determine from the engine data signal 314 that the internal combustion engine requires a higher, or lower, input of hydrogen and oxygen gases. The control system 301 may accordingly transmit a control signal 318 instructing the reactor system 313 to vary a configuration of the reactor cell assembly 310 with a view to increasing or decreasing the production rate of hydrogen and oxygen gases to the ICE.

In the illustrated embodiment, the monitoring system 350 may also include one or more level sensors 360 configured to measure the level of electrolyte solution inside the reactor cell assembly 310. Alternatively or additionally, the monitoring system 350 may include one or more overflow sensors 365, which are configured to determine if the level of electrolyte solution and potassium hydroxide (KOH) inside the tank system 312 exceeds a predetermined height. In some cases, the level sensors 360 and/or the overflow sensors 365 can be coupled to the tank system 312. For example, the level sensors 360 and/or the overflow sensors 365 may be provided within the tank system 312. In some other cases, the level sensors 360 and/or the overflow sensors 365 can be located within the reactor cell assembly 310 directly.

In some cases, where the level sensors 360 are positioned inside the tank system 312, the sensors 360 are configured to transmit sensor signals 312a to the control system 301, where the sensor signals 312a identify the amount of solution in the reactor cell assembly 310. In other cases, where the level sensors 360 are positioned outside the tank system 312, the sensors 360 are configured to transmit sensor signals 312a′ to the control system 301 that may similarly identify the amount of solution in the reactor cell assembly 310. The control system 301 can receive and process the sensor signals, and can transmit a control signal 319 to the solution pump 390 to direct it to cease supplying electrolyte solution to the tank system 312 if the solution level is determined to exceed a predetermined threshold.

Likewise, if the overflow sensors 365 are positioned inside the tank system 312, said sensors are configured to transmit sensor signals 312b to the control system 301 identifying whether or not the electrolyte solution and KOH level within the tank system 312 exceeds a predetermined height. If the overflow sensors 365 are positioned outside the tank system 312, said sensors are configured to transmit sensor signals 312b′ similarly identifying whether or not the solution level within the tank system 312 exceeds the predetermined height.

In embodiments where the overflow sensors 365 are utilized, the control system 301 may be configured to transmit a control signal 382a to a pump 380, coupled to the tank system 312. The control signal 382a directs the pump 380 to pump solution and KOH out of the tank system 312 and back into the reactor cell assembly 310. The solution and KOH may then be re-used inside of the reactor cell assembly 310 for electrolysis.

The reactor system 313 may also include an electronic control module (“ECU”) 305, coupled to reactor relays 304, 306, 308 and 309. The reactor relays 304, 306, 308 and 309 are in-turn connected to the electrolytic cells of the reactor cell assembly 310. The ECU 305 may, for example, include a circuit board. In various embodiments disclosed herein, the ECU 305 is configured to control the operation of reactor relays 304, 306, 308 and 309, which in turn controls the configuration of the corresponding reactor cell assembly 310. While the ECU 305 has been illustrated herein as a standalone unit, the ECU 305 may alternatively be housed within the control system 301.

The reactor relays 304, 306, 308 and 309 may be electrical switches that are switchable between an active state and an inactive state. The operating state of each reactor relay 304, 306, 308 and 309 may be determined by the control system 301.

In some embodiments, the control system 301 may make a determination as to which reactor relay to activate based on information contained in the temperature signals 316a, current signals 370a or the engine data signal 314. The control system 301 may then transmit a control signal 318 instructing the ECU 305 to activate the relevant reactor relay 304, 306, 308 and 309. In particular, the ECU 305 may activate the relevant reactor relay 304, 306, 308 and 309 by transmitting an activation signal 305a, 305b, 305c or 305d, respectively, to the relevant reactor relay. In various embodiments described herein, activating each reactor relay 304, 306, 308 and 309 results in a modified configuration of reactor cell assembly 310.

In at least one embodiment disclosed herein, each of the reactor relays 304, 306, 308, and 309 is a 12 VDC 4-pin, single pole, single throw relay. In some other embodiments, each reactor relay 304, 306, 308 and 309 is a 5-pin relay. In various embodiments, the reactor relay 304, 306, 308 and 309 are activated by providing to the electromagnetic coils of the corresponding relays.

The reactor system 313 further includes a power source 303, which is connected, at the positive voltage terminal, to the reactor relays 304, 306, 308 and 309. The power source 303 provides a continuous positive voltage signal 301a, 301b, 301c and 301d to the reactor relays 304, 306, 308 and 309, respectively. When a reactor relay is activated by the ECU 305 via a suitable activation signal, a positive voltage is provided across the electrolytic cells connected to that reactor relay, thereby activating them. Depending on which reactor relay, and accordingly which electrolytic cells are activated, the cell assembly 310 operates in a unique cell configuration.

The power source 303 may be, for example, a 12-volt direct current (DC) voltage source, or a 13.8-volt DC source. In other cases, the power source 303 may be an alternating current (AC) voltage source. Where the power source 303 is an AC voltage source, a step-up or step down AC-DC power converter may be coupled to the power source in order to generate a 12-volt DC output or a 13.8-volt DC output.

In at least some embodiments, the power source 303 may be a power circuit provided in the ECU 305. In some embodiments, the power source 303 may be separate from the ECU 305. However, in such embodiments, the power source 303 can be electrically coupled to the ECU 305. For example, as illustrated, the power source 303 is configured to receive control signals 303a from the ECU 305, where the control signals 303a control the operation of the power source 303 in order to selectively activate or deactivate the power source 303.

A reactor control board (RCB) 302, which may be housed within the ECU 305, is coupled to the negative voltage terminal 303b of the power source 303. The RCB 302 is configured to provide a negative voltage 302′ to the reactor cell assembly 310 from the power source 303. The RCB 302 is also configured to control the current in the reactor cell assembly 310 by providing a negative voltage to the assembly 310.

In various embodiments, the RCB 302 is configured to turn the reactor cell assembly 310 on and off based on the prescribed current limit of the assembly 310. For example, if the reactor cell assembly 310 is set to an operational current of 10 A (amperes), but is being provided 20 A, the RCB 302 operates to keep the reactor cell assembly 310 on for one second and turns it off the next second. As a result, the reactor cell assembly 310 averages 10 A over two seconds, making the average current consumption of the reactor cell assembly 310 to be within the prescribed limits. In various cases, the RCB 302 consists of metal-oxide-semiconductor field-effect transistors (MOSFETs).

While the RCB 302 has been illustrated in FIG. 3A as being housed within the ECU 305, in other cases the RCB 302 may be a separate unit from the ECU 305.

Reference is now made to FIG. 3B, which illustrates the reactor system 313 of FIG. 3A in detail. The reactor system 313 of FIG. 3B includes the ECU 305, the RCB 302, the power source 303, the reactor relays 304, 306, 308, and 309 and the reactor cell assembly 310.

The reactor cell assembly 310 contains an array of electrolytic cells 310a-310l. In particular, in the illustrated embodiment, the array of electrolytic cells contains a first electrolytic cell 310a, a second electrolytic cell 310b, a third electrolytic cell 310c, a fourth electrolytic cell 310d, a fifth electrolytic cell 310e, a sixth electrolytic cell 310f, a seventh electrolytic cell 310g, an eighth electrolytic cell 310h, a ninth electrolytic cell 310i, a tenth electrolytic cell 310j, an eleventh electrolytic cell 310k, and a twelfth electrolytic cell 310l. Each electrolytic cell may be formed from a parallel arrangement of two laterally spaced electrode plates. While the reactor cell assembly 310 has been illustrated with twelve electrolytic cells, the reactor cell assembly 310 may, in other cases, include a different number of electrolytic cells.

In the illustrated embodiment, the electrolytic cells 310a-310l of the reactor cell assembly 310 are divided between a first cell unit 311a and a second cell unit 311b, arranged in a parallel configuration with respect to each other. Each of the first cell unit 311a and second cell unit 311b contains six electrolytic cells stacked in series. In some other embodiments, a different arrangement of the electrolytic cells 310a-310l may be provided.

The first and second cell units 311a, 311b share a common negative voltage applied by the RCB 302 via the negative voltage signal 302′. For example, the RCB 302 may be connected to a central electrode plate interposed between cells 310f and 310g of the first and second cell units 311a, 311b, respectively.

As previously mentioned, the reactor relays 304, 306, 308, and 309 are connected to the ECU 305, as well as to the positive terminal of the power supply 303. When in operation, the first reactor relay 304 provides a positive voltage to the outermost electrode plates of the electrolytic cells 310a and 310l. Similarly, when the second reactor relay 306 is in operation, it is configured to provide positive voltage to an outer electrode plate of cell 310b, and an outer electrode plate of cell 310k. The third reactor relay 308, when in operation, similarly provides positive voltage to an outer electrode plate of cell 310c, and an outer electrode plate of cell 310j. Operating the fourth reactor relay 309 provides positive voltage to an outer electrode plate of cell 310d, and an outer electrode plate of cell 310i. The various cells to which the relays are connected are provided here as examples only. In some other embodiments, the relays may be connected to different combination of cells in the reactor cell assembly 310.

In the various embodiments illustrated herein, the ECU 305 is configured to activate only one of the four reactor relays 304, 306, 308 and 309 at any given time. If a reactor relay is already activated, and if it is desired to activate a different reactor relay, the ECU 305 is configured to first de-activate the activated relay, before activating the desired relay. In various cases, the ECU 305 may be instructed by the control system 301 to trigger a certain reactor relay to activate or deactivate. For example, the control system 301 may determine the ambient temperature in the proximity of the reactor system 313 using information from the temperature signal 316a and may determine what configuration of the reactor cell assembly 310 is suitable for that condition. The control system 301 may then instruct the ECU 305 to activate a particular reactor relay in order to change the configuration of the reactor assembly 310 to the suitable configuration.

In some other cases, the control system 301 may trigger the ECU 305 to alter the configuration of the reactor cell assembly 310 based on the current consumption of the reactor system 313. For example, the control system 301 may determine the temperature and/or gas production rate of the reactor system 313 based on the detected current consumption. In such cases, the control system 301 may determine the suitable configuration of the reactor cell assembly 310 that increases or decreases the current consumption in order to vary the gas production rate and/or the reactor system temperature. The control system 301 may then instruct the ECU 305 to activate the suitable reactor relay.

In at least some cases, the reactor system 313 may also include electrical fuses to provide electrical protection when the system is switching between different relays.

To activate the first reactor relay 304, the ECU 305 transmits a first activation relay signal 305a to the first reactor relay 304. Upon activation, the first reactor relay 304 may provide positive voltage across the electrode plates of cells 310a and 310l. The positive voltage generates a potential difference between the outermost electrode plate of cell 310a, and the innermost electrode plate of cell 310f (receiving the negative voltage signal 302′ from the RCB 302). Similarly, a potential difference is generated between the outermost electrode plate of cell 310l, and the innermost electrode plate of cell 310g (receiving the negative voltage signal 302′ from the RCB 302). In this manner, the first reactor relay 304 activates all twelve electrolytic cells 310a-310l of reactor cell assembly 310.

To activate the second reactor relay 306, the ECU 305 transmits a second activation relay signal 305b to the second reactor relay 306. Upon activation, the second reactor relay 306 may provide positive voltage across the electrode plates of cells 310b and 310k. The positive voltage generates a potential difference between the outermost electrode plate of cell 310b, and the innermost electrode plate of cell 310f (receiving the negative voltage signal 302′ from the RCB 302). Similarly, a potential difference is generated between the outermost electrode plate of cell 310k, and the innermost electrode plate of cell 310g (receiving the negative voltage signal 302′ from the RCB 302). Accordingly, the second reactor relay 308 activates ten electrolytic cells 310b-310k of reactor cell assembly 310. The two outermost electrolytic cells, 310a and 310l, of the reactor cell assembly 310, remain inactive, as they do not receive any voltage or current.

To activate the third reactor relay 308, the ECU 305 transmits a third activation reactor signal 305c to the third reactor relay 308. Upon activation, the third reactor relay 308 provides positive voltage across the electrode plates of cells 310c and 310j. The positive voltage generates a potential difference between the outermost electrode plate of cell 310c, and the innermost electrode plate of cell 310f (receiving the negative voltage signal 302′ from the RCB 302). Similarly, a potential difference is generated between the outermost electrode plate of cell 310j, and the innermost electrode plate of cell 310g (receiving the negative voltage signal 302′ from the RCB 302). Accordingly, the third reactor relay 308 activates only eight electrolytic cells 310c-310j of reactor cell assembly 310. The four outermost electrolytic cells, 310a, 310b, 310k, and 310l of the reactor cell assembly 310, remain inactive, as they do not receive voltage or current.

To activate the fourth reactor relay 309, the ECU 305 transmits a fourth activation relay signal 305d to the fourth reactor relay 309. Upon activation, the fourth reactor relay 309 may provide positive voltage across the electrode plates of cells 310d and 310i. The positive voltage generates a potential difference between the outermost electrode plate of cell 310d, and the innermost electrode plate of cell 310f (receiving the negative voltage signal 302′ from the RCB 302). Similarly, a potential difference is generated between the outermost electrode plate of cell 310i, and the innermost electrode plate of cell 310g (receiving the negative voltage signal 302′ from the RCB 302). Accordingly, the fourth reactor relay 309 activates six electrolytic cells 310d-310i of reactor cell assembly 310. The six outermost electrolytic cells, 310a, 310b, 310c, 310j, 310k, and 310l, of the reactor cell assembly 310, remain inactive, as they do not receive any voltage or current.

While four separate reactor relays 304, 306, 308 and 309 have been illustrated in FIGS. 3A and 3B, in some cases, the reactor relays may be integrated into a single reactor relay unit. The single reactor relay unit may be configured to be switchable between at least four active modes of operation that correspond in function to the first, second, third and fourth reactor relays. As well, while four reactor relays have been shown, more or less than four reactor relay units may be employed in the reactor system 313 to connect the power system 303 to various electrolytic cells in the reactor cell assembly 310.

Reference is now made briefly to FIG. 3C, which illustrates a simplified block diagram of the reactor system 313 of FIG. 3B. Similar to the reactor system 313 of FIG. 3B, the reactor system 313 includes the ECU 305, the RCB 302, the power source 303, a reactor relay system 350 and the reactor cell assembly 310.

The reactor relay system 350 can include one or more of the reactor relays 304, 306, 308 and 309. For example, in some cases, reactor relay system 350 can include all of the reactor relays 304, 306, 308 and 309. In other cases, reactor relay system 350 can include only a subset of the reactor relays 304, 306, 308 and 309. For example, reactor relay system 350 can include only one of the reactor relays, two of the reactor relays, or three of the reactor relays 304, 306, 308 and 309. Accordingly, the reactor relay system 350 can include any combination of reactor relays that activate any combination of cell configurations. In some cases, the reactor relay system 350 can also include more than one reactor relay for activating the same cell configuration. This has the advantage of providing back-up reactor relays in case one or more reactor relays malfunction. In still other cases, the reactor relay system 350 can include a single reactor relay that is configured to switch between one or more active modes of operations. For example, the single reactor relay can perform the function of one or more of the first, second, third and/or fourth reactor relays.

Reactor relay system 350 can also include reactor relays that are not illustrated in the example embodiment of FIGS. 3A and 3B. For example, reactor relay system 350 can include a reactor relay for activating only four cells of the reactor cell assembly 310. For example, a reactor relay can be provided for applying a positive voltage across the electrode plates of cells 310e and 310h. The positive voltage may accordingly generate a potential difference between the outermost electrode plate of cell 310e, and the innermost electrode plate of cell 310f (receiving the negative voltage signal 302′ from the RCB 302). Similarly, a potential difference may be generated between the outermost electrode plate of cell 310h, and the innermost electrode plate of cell 310g (receiving the negative voltage signal 302′ from the RCB 302). Similarly, the reactor relay system 350 can also include a reactor relay for activating only two cells of the reactor cell assembly 310. For example, the reactor relay may provide a positive voltage across the electrode plates of cells 310f and 310g. The positive voltage generates a potential difference between the outermost electrode plate of cell 310f, and the innermost electrode plate of cell 310f (receiving the negative voltage signal 302′ from the RCB 302). Likewise, a potential difference is generated between the outermost electrode plate of cell 310g, and the innermost electrode plate of cell 310g (receiving the negative voltage signal 302′ from the RCB 302).

Reference is now briefly made to FIG. 4A, which illustrates a schematic representation of a reactor system in a first configuration 400A according to one example. Configuration 400A illustrates a connection between the ECU 305, RCB 302, the power supply 303, the first reactor relay 304, and the reactor cell assembly 310.

As shown, the first reactor relay 304 is connected by a conductive wire to conductive hooks 402 and 404. Hooks 402 and 404 are aligned with, and connected to, the outermost electrode plates of cells 310a and 310l, respectively, of the reactor assembly 310. The RCB 302 applies a negative voltage signal 302′ to the reactor cell assembly 310 through a separate wire. The separate wire is connected to a third conductive hook 406, located centrally between cells 310f and 310g.

In at least some embodiments, the first reactor relay 304 is activated by an activation signal 305a generated by the ECU 305. Once activated, the first reactor relay 304 causes a voltage of 12 V or 13.8 V, received from the power source 303 via positive voltage signal 301a, to be applied across electrolytic cells 310a and 310f, as well as across electrolytic cells 310l and 310g of the reactor cell assembly 310. A potential of 2 V or 2.3 V is accordingly generated across each of the twelve electrolytic cells 310a-310l.

In some cases, the first reactor relay 304 is activated when the temperature signals 316a record an ambient temperature, around the reactor system 313, in the ideal operating temperature range. In a non-limiting example, the ideal operating temperature range may be approximately 20 to 70 degree Celsius.

In other cases, the first reactor relay 304 is activated when the current signal 370a indicates that the reactor system 313 is consuming an ideal level of current. Where the reactor system 313 is consuming an ideal level of current, this may indicate that the reactor system 313 is producing gas at an ideal rate and/or is otherwise operating in the ideal operating temperature range. By way of a non-limiting example, the ideal level of current consumption may be approximately 20 A, which may indicate an ideal rate of gas production for the reactor system 313 of approximately 1.5 L of gas per minute, and an ideal operating temperature range of between 20 to 70 degree Celsius.

Reference is next briefly made to FIG. 4B, which illustrates a schematic representation of a reactor system 313 in a second configuration 400B according to another example. Configuration 400B illustrates a connection between the ECU 305, RCB 302, the power supply 303, the second reactor 306, and the reactor cell assembly 310.

As shown, the second reactor relay 306 may be connected by a conductive wire to conductive hooks 408 and 410. Hooks 408 and 410 are aligned with, and connected to, the outer electrode plates of cells 310b and 310k.

In at least some embodiments, the second reactor relay 306 is activated by an activation signal 305b generated by the ECU 305. Once activated, the second reactor relay 306 causes a voltage of 12 V or 13.8 V, received from the power source 303 via positive voltage signal 301b, to be applied across electrolytic cells 310b and 310f, as well as across electrolytic cells 310k and 310g of the reactor cell assembly 310. A potential of 2.4 V or 2.76 V is accordingly generated across each of the ten activated electrolytic cells 310b-310k. Compared to the embodiment where the first reactor relay 304 is activated, the voltage across each active cell in this configuration (i.e. where the second reactor relay 306 is activated) increases by 20%. In various cases, an increase of 20% in the voltage across each cell increases the rate of gas production (i.e. byproduct gas product due to electrolysis) by about 200% from the whole rector cell assembly 310. The increase in the gas production may also provide the advantage of heating up the reactor cell assembly 310.

In some cases, the second reactor relay 306 is activated when the temperature signals 316a record an ambient temperature, around reactor system 313, below the ideal operating temperature range. For example, the second reactor relay 306 may be activated when the operating temperature is in the range of approximately 0 to 50 degree Celsius. In these cases, the reactor system 313 may require some initial heating to carry out the electrolytic process.

In other cases, the second reactor relay 306 is activated when the current signal 370a indicates that the reactor system 313 is consuming below an ideal level of current. Where the reactor system 313 is consuming below the ideal level of current, this may indicate that the reactor system 313 is generating gas at a below ideal rate, and/or is operating below the ideal operating temperature range. By way of a non-limiting example, the second reactor relay 306 may be activated when the current consumption of the reactor system 313 is measured in a range between 6 A to 10 A. This may, accordingly, indicate that the reactor system 313 is producing gas at half the expected rate (e.g. approximately 0.75 L liters of gas per minute), and may otherwise be operating at a lower than ideal temperature range (e.g. 0 to 50 degree Celsius).

According to some embodiments, in order to heat the reactor system 313 or increase the current consumption level, the control system 301 or the ECU 305 may transmit an activation signal 305b to activate the second reactor relay 306. If the first reactor relay 304 is already activated, the control system 301 or the ECU 305 may first de-activate the first reactor relay 304, and then activate the second reactor relay 306, such that only one reactor relay is activated at any given time instance.

Upon activating the second reactor relay 306, the configuration of the reactor cell assembly 310 is modified such that only ten electrolytic cells are activated. In this mode of operation, each active cell receives increased voltage (2.4V or 2.76V), resulting in increased total gas production as compared to a twelve active cell configuration. The increased gas production may help in rapidly warming the reactor system 313 to its ideal operating temperature range.

When the reactor system 313 has reached the ideal operating temperature and/or current consumption level, the control system 301 or ECU 305 may de-activate the second reactor relay 306, and re-activate the first reactor relay 304, in order to return the reactor cell assembly 310 to its default mode of operation.

In an application where the reactor cell assembly 310 provides hydrogen and oxygen gases to an internal combustion engine to increase fuel efficiency, as discussed in in the context of FIGS. 2A and 2B, the control system 301 may also direct the ECU 305 to activate the second reactor relay 306 to increase the rate of electrolysis, and accordingly the production of byproduct gases (such as, hydrogen and oxygen gases).

For example, the control system 301 may receive information from an internal combustion engine or a corresponding electronic control module, via engine data signal 314, that an increased amount of hydrogen and oxygen gases is required. In this case, the control system 301 may direct the ECU 305 to deactivate the first reactor relay 304, and activate the second reactor relay 306, in order to modify the configuration of the reactor cell assembly 310 from twelve active cells to ten active cells. The modification to ten active cells may result in a two-fold increase in gas production as compared to the twelve active cell configuration (for example, an increase from 1.5 liters/minutes to 3.0 liters/minutes).

Reference is now made to FIG. 4C, which illustrates a schematic representation of an electrolytic reactor system in a third configuration 400C according to another example. Configuration 4000 illustrates a connection between the ECU 305, RCB 302, the power supply 303, the third reactor 308, and the reactor cell assembly 310.

As shown, the third reactor relay 308 may connect to conductive hooks 412 and 414. Hooks 412 and 414 are aligned with, and connected to, the outer electrode plates of cells 310c and 310j. The connection between the third reactor relay 308 and the conductive hooks 412 and 415 may be a wired connection.

In at least some embodiments, the third reactor relay 308 is activated by an activation signal 305c generated by the ECU 305. Once activated, the third reactor relay 308 causes a voltage of 12 V or 13.8 V, received from the power source 303 via positive voltage signal 301c, to be applied across electrolytic cells 310c and 310f, as well as across electrolytic cells 310j and 310g of the reactor cell assembly 310. A potential of 3 V or 3.45 V is accordingly generated across each of the eight activated electrolytic cells 310c-310j. Compared to the embodiment where the first reactor relay 304 is activated, the voltage across each active cell in this configuration (i.e. where the third reactor relay 308 is activated) increases by 50%. In various cases, an increase of 50% in the voltage across each cell increases the rate of byproduct gas production by about 400% from the whole rector cell assembly 310. The increase in the gas production may also provide the advantage of heating up the reactor cell assembly 310.

In some cases, the third reactor relay 308 is activated when the ambient temperature, around the reactor system 313, is determined to be within a range of low operating temperature. A non-limiting example of a low temperature may be in the range of approximately 0 to −28 degree Celsius.

In other cases, the third reactor relay 308 is activated where the current consumption of the reactor system 313 is determined to be within a range of very low current consumption. A non-limiting example of very low current consumption may be a range between 0 A to 5 A. This may result from the decreased ambient temperature associated with the reactor system 313.

Current consumption in this range may result in gas generation at a very low production rate. Under such conditions, current consumption by a twelve or ten active cell configuration may not be sufficient to generate desired gas production and/or generate sufficient heat to carry out electrolysis in reactor system 313. Accordingly, the control system 301 or the ECU 305 may activate the third reactor relay 308, and de-activate the first or second reactor relay, as the case may be. In this manner, the configuration of the reactor cell assembly 310 is modified from a twelve or ten active cell configuration, to an eight active cell configuration. The higher rate of gas production resulting from the eight cell configuration may help in the rapid warming-up of the reactor system 313 to its ideal operating temperature range.

When the reactor system 313 has reached its ideal operating temperature range and/or current consumption level, the control system 301 or the ECU 305 may de-activate the third reactor relay 308, and re-activate either the first or second reactor relays, as the case may be.

In an application where the reactor cell assembly 310 provides hydrogen and oxygen gas to an internal combustion engine, the third reactor relay 308 may also be activated when the control system 301 receives information from the engine data signal 314 that the internal combustion engine requires a higher, or faster, input of hydrogen and oxygen gases. In these cases, the third reactor relay 308 may be activated if the cell configuration generated by the first or second reactor relays would not produce sufficient volumes of gas.

Reference is now made to FIG. 4D, which illustrates a schematic representation of an electrolytic reactor system in a fourth configuration 400D according to another example. Configuration 400D illustrates a connection between the ECU 305, RCB 302, the power supply 303, the fourth reactor 309, and the reactor cell assembly 310.

As shown, the fourth reactor relay 309 may connect to conductive hooks 416 and 418. Hooks 416 and 418 are aligned with, and connected to, the outer electrode plates of cells 310d and 310i. The connection between the fourth reactor relay 309 and the conductive hooks 416 and 418 may be a wired connection.

In at least some embodiments, the fourth reactor relay 309 is activated by an activation signal 305d generated by the ECU 305. Once activated, the fourth reactor relay 309 causes a voltage of 12V or 13.8V, received from the power source 303 via positive voltage signal 301d, to be applied across electrolytic cells 310d and 310f, as well as across electrolytic cells 310g and 310i of the reactor cell assembly 310. A potential of 4V or 4.6V is accordingly generated across each of the six activated electrolytic cells 310d-310i. Compared to the embodiment where the first reactor relay 304 is activated, the voltage across each active cell in this configuration (i.e. where the fourth reactor relay 309 is activated) increases by 100%. In various cases, an increase of 100% in the voltage across each cell increases the rate of byproduct gas production by about 800% from the whole rector cell assembly 310. The increase in the gas production may also provide the advantage of heating up the reactor cell assembly 310.

Similar to the third reactor relay 308, the fourth reactor relay 309 may also be activated when the ambient temperature, around the reactor system 313, is determined to be within a range of low operating temperature. A non-limiting example of a low temperature may be in the range of approximately 0 to −28 degree Celsius.

In other cases, the fourth reactor relay 309 is also activated where the current consumption of the reactor system 313 is determined to be within a range of very low current consumption. A non-limiting example of very low current consumption may be a range between 0 A to 5 A.

In various cases, the fourth reactor relay 309 can be activated where current consumption by a twelve, ten or eight active cell configuration may not be sufficient to generate desired gas production and/or generate sufficient heat to carry out electrolysis in reactor system 313. Accordingly, the control system 301 or the ECU 305 may activate the fourth reactor relay 309, and de-activate the first, second or third reactor relay, as the case may be. In this manner, the configuration of the reactor cell assembly 310 is modified from a twelve, ten or eight active cell configuration, to a six active cell configuration. The higher rate of gas production resulting from the six cell configuration may help in the rapid warming-up of the reactor system 313 to its ideal operating temperature range.

When the reactor system 313 has reached its ideal operating temperature range and/or current consumption level, the control system 301 or the ECU 305 may de-activate the fourth reactor relay 309, and re-activate either the first, second or third reactor relays, as the case may be.

In an application where the reactor cell assembly 310 provides hydrogen and oxygen gas to an internal combustion engine, the fourth reactor relay 309 may also be activated when the control system 301 receives information from the engine data signal 314 that the internal combustion engine requires a higher, or faster, input of hydrogen and oxygen gases. In these cases, the fourth reactor relay 309 may be activated if the cell configuration generated by the first, second or third reactor relays would not produce sufficient volumes of gas.

In various embodiments, in the first mode of operation, where the first reactor relay 304 is activated to apply a voltage of 13.8V to the reactor cell assembly 310, the reactor cell assembly 310 may consume a total current of 15 A at room temperature. In cases where the first reactor relay 304 is connected to 12 cells in the reactor cell assembly 310, a voltage of 2.3V is applied to each electrolytic cell, and each electrolytic cell individually consumes approximately 1.25 A. In such cases, the total gas production of the reactor cell assembly 310 may be approximately 1 liters/minutes, and total gas production per cell may be approximately 0.0833 liters/minute.

In cases where the reactor cell assembly 310 is operating in the second mode of operation, i.e. where the second reactor relay 306 is activated to apply a voltage of 13.8V to the reactor cell assembly 310, the reactor cell assembly 310 may consume a total current of 30 A at room temperature. In cases where the second reactor relay 306 is connected to 10 cells in the reactor cell assembly 310, a voltage of 2.76V can be applied to each electrolytic cell, and each electrolytic cell individually consumes approximately 3 A. In such cases, the total gas production of the reactor cell assembly 310 may be approximately 2.0 liters/minutes, and total gas production per cell may be approximately 0.2 liters/minute. By comparison to the first mode of operation, the efficiency of each cell in this case is increased by 240%, and the total efficiency of the entire reactor cell assembly 310 is increased by 200%.

In cases where the reactor cell assembly 310 is operating in the third mode of operation, i.e. where the third reactor relay 308 is activated to apply a voltage of 13.8V to the reactor cell assembly 310, the reactor cell assembly 310 may consume a total current of 60 A at room temperature. In cases where the third reactor relay 308 is connected to 8 cells in the reactor cell assembly 310, a voltage of 3.45V is applied to each electrolytic cell, and each electrolytic cell individually consumes approximately 7.5 A. In such cases, the total gas production of the reactor cell assembly 310 may be approximately 4.0 liters/minutes, and total gas production per cell may be approximately 0.5 liters/minute. By comparison to the first mode of operation, the efficiency of each cell is increased by 600% in this case, and the efficiency of the entire reactor cell assembly 310 is increased by 400%.

In cases where the reactor cell assembly 310 is operating in the fourth mode of operation, i.e. where the fourth reactor relay is activated to apply a voltage of 13.8V to the reactor cell assembly 310, the reactor cell assembly 310 may consume a total current of 120 A at room temperature. In cases where the fourth reactor relay is connected to 6 cells in the reactor cell assembly 310, a voltage of 4.6V is applied to each electrolytic cell and each electrolytic cell individually consumes approximately 20 A. In such cases, the total gas production of the reactor cell assembly 310 may be approximately 8.0 liters/minutes, and total gas production per cell may be approximately 1.33 liters/minute. By comparison to the first mode of operation, the efficiency of each cell is increased by 1600% in this case, and the efficiency of the entire reactor cell assembly 310 is increased by 800%.

Table 2 provides an example of voltages and current measurements associated with the reactor cell assembly 310, as well gas production rates, for different reactor cell assembly 310 configurations:

TABLE 2
Reactor Cell Assembly Configurations and Corresponding Measurements

| CONFIGURATION | 12 CELL | 10 CELL | 8 CELL | 6 CELL |
|---|---|---|---|---|
| Total current (A) | 15 | 30 | 60 | 120 |
| Current per cell (A) | 1.25 | 3 | 7.5 | 20 |
| Voltage (V) | 13.8 | 13.8 | 13.8 | 13.8 |
| Voltage per cell (V) | 2.3 | 2.76 | 3.45 | 4.6 |
| Total gas production (Liters/Minute) | 1 | 2 | 4 | 8 |
| Gas production per cell (Liters/Minute) | 0.0833 | 0.2 | 0.5 | 1.33 |
| Total efficiency (%) of unit as whole | 100 | 200 | 400 | 800 |
| Efficiency (%) of each working cell | 100 | 240 | 600 | 1,600 |
| Approximate percent increase in gas | — | 140 | 500 | 1,500 |
| production per cell compared to twelve (12) | | | | |
| cell configuration | | | | |

Table 3 provides an example of optimal configurations for reactor cell assembly 310 with respect to different ambient temperatures in proximity to the reactor system 313:

TABLE 3
Example Optimal Reactor Cell Assembly Configurations
for Different Ambient Temperatures.

| CONFIGURATION | 12 CELL | 10 CELL | 8 CELL | 6 CELL |
|---|---|---|---|---|
| Current | 1 A | 2 A | 4 A | 8 A |
| Gas Production | X | 2X | 4X | 8X |
| | liters/ | liters/ | liters/ | liters/ |
| | minute | minute | minute | minutes |
| Temperature | 20 to 70 | 0 to 70 | −28 to 70 | −28 to 70 |
| Range (° C.) | | | | |

Table 4 provides further example gas production and current consumption levels for different reactor cell assembly 310 configurations. In particular, the values in Table 4 assume the ambient temperatures in proximity of the reactor system 313 is slightly warmer than the room temperature (e.g., 30 degree Celsius), and that a voltage supply of 13.8 volts is being applied to the reactor cell assembly 310. In colder ambient temperatures, heat generated by switching cell configurations is used for warming-up reactor solution inside of the reactor system 313 to catalyze the electrolysis process, as well as to increase the reaction rate. However, at temperatures warmer than ambient room temperatures, the reactor system 313 does not require heating to begin electrolysis. Accordingly, energy generated by switching cell configurations when the reactor assembly 313 is operating at temperatures warmer than ambient room temperature is simply dissipated from the system in the form of heat. Table 4, below, demonstrates the extent to which energy is dissipated in the form of heat when the reactor system 313 is operated at temperatures slightly warmer than ambient room temperatures. The values in Table 4 also demonstrate the extent to which heat generated by the system is increased by each switch of cell configuration. In colder ambient temperatures, this heat is used for warming-up the reactor solution:

TABLE 4
Example Gas Production Rates and Current Consumption
Levels for Different Cell Reactor Configurations

| CONFIGURATION | 12 CELL | | 10 CELL | | 8 CELL | | 6 CELL | |
|---|---|---|---|---|---|---|---|---|
| Voltage (V) | 13.8 | V | 13.8 | V | 13.8 | V | 13.8 | V |
| Temperature (° C.) | 30° | C. | 30° | C. | 30° | C. | 30° | C. |
| Gas production (Liters/Minute) | 1.07 | L/min | 1.25 | L/min | 1.875 | L/min | 2 | L/min |
| Percentage (%) increase of gas production | — | | 16.82 | | 50 | | 6.66 | |
| over previous configuration | | | | | | | | |
| Current Consumption (A) | 14.3 | A | 20 | A | 41 | A | 52 | A |

| | | | | |
|---|---|---|---|---|
| Percentage (%) increase of current | — | 39.86 | 105 | 26.82 |
| consumption over previous configuration | | | | |
| Percent (%) energy loss | — | 16.71 | 38.87 | 48.59 |

As shown in Table 4, switching the reactor cell assembly 310 from a 12 cell configuration to a 10 cell configuration increases gas production by 16.82% and increases current consumption by 39.86%. This results in a 16.71% of energy loss from the system in the form of heat. Similarly, switching the reactor cell assembly 310 from a 10 cell configuration to an 8 cell configuration results in an increase in gas production by 50% and an increase in current consumption by 105%. This results in a 38.87% energy loss in the form of heat. Further, switching from a 10 cell configuration to a 6 cell configuration results in a 48.59% increase in heat generated by the system. Accordingly, the amount of heat loss generated by the reactor system 313 increases significantly with each switch of cell configuration (e.g., 16.71% to 38.87% to 48.59%). Although the increase in heat is simply dissipated from the system at temperatures warmer than room temperature, this same heat can be used for warming-up the reactor system 313 at colder ambient temperatures. Accordingly, the values in Table 4 demonstrate the extent to which the reactor system 313 can be warmed-up by switching cell configurations. In various cases, heat losses can be reduced at warmer ambient temperature by decreasing the voltage across cells to allow each cell to produce less gas. As previously mentioned, in order to accommodate for the variation in current consumption as a result of switching the reactor relays, the reactor system 313 may include electrical fuses to provide for overcurrent protection.

Table 5 provides still further example gas production and current consumption levels for different reactor cell assembly 310 configurations. Table 5 assumes that the ambient temperature in proximity of the reactor system 313 is near ideal room temperature (e.g., 24 degree Celsius), and that a voltage supply of 13.8V is being applied to the reactor cell assembly 310. Table 5, however, demonstrates the operation of the reactor cell assembly 310 for different current consumption and gas production values:

TABLE 5
Example Gas Production Rates and Current Consumption
Levels for Different Cell Reactor Configurations

| Configuration | 12 CELL | | 10 CELL | | 8 CELL | | 6 CELL | |
|---|---|---|---|---|---|---|---|---|
| Voltage per cell (V) | 2.3 | V | 2.76 | V | 3.45 | V | 4.6 | V |
| Current consumption (A) | 14 | A | 24 | A | 35 | A | 52 | A |
| Percentage increase in current consumption | | | 71% | | 46% | | 49% | |
| over previous configuration | | | | | | | | |
| Gas production (L/min) | 1 | L/min | 1.58 | L/min | 1.875 | L/min | 2.5 | L/min |

| | | | |
|---|---|---|---|
| Percentage increase in gas production | 58% | 20% | 14% |
| compared to previous configuration | | | |
| Percentage increase in gas production | 58% | 87.5% | 150% |
| compared to twelve (12) cell configuration | | | |
| Percent energy loss | 13% | 26% | 35% |

As shown in Table 5, switching from a 12 cell configuration to a 10 cell configuration results in an increase in current consumption by 71%, while only resulting in an increase by gas production by 58%. The 13% difference between current consumption (e.g., energy input) and gas output production (e.g., energy output) represents the amount of energy lost from the system in the form of heat. Similarly, when switching from a 10 cell configuration to an 8 cell configuration, current consumption increases by 46%, whereas gas output production only increases by 20%. Accordingly, the difference of 26% also expresses the energy loss due to heat. Likewise, when the reactor switches from an 8 cell configuration to a 6 cell configuration, current consumption increases by 49%, whereas gas production increases only by 14%, resulting in an energy difference of 35%. Accordingly, it can also be observed from Table 5 that the amount of heat loss generated by the reactor system 313 increases significantly with each switch of cell configuration. As stated previously, at colder ambient temperatures, this heat can be used for warming-up solution inside of the reactor system 313.

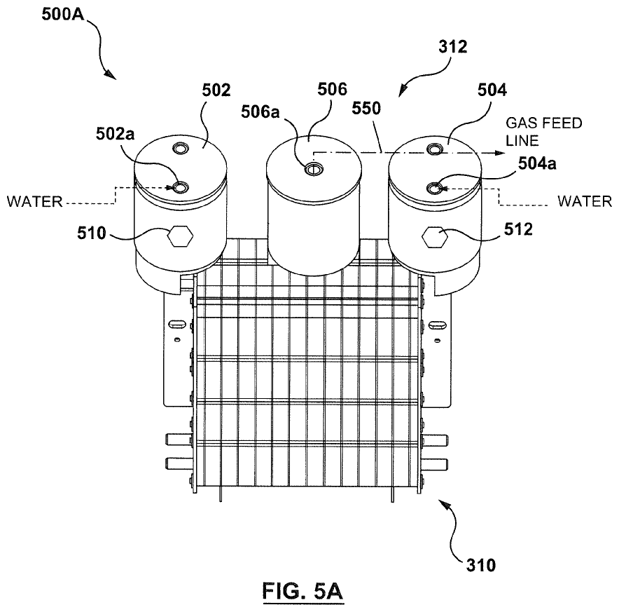

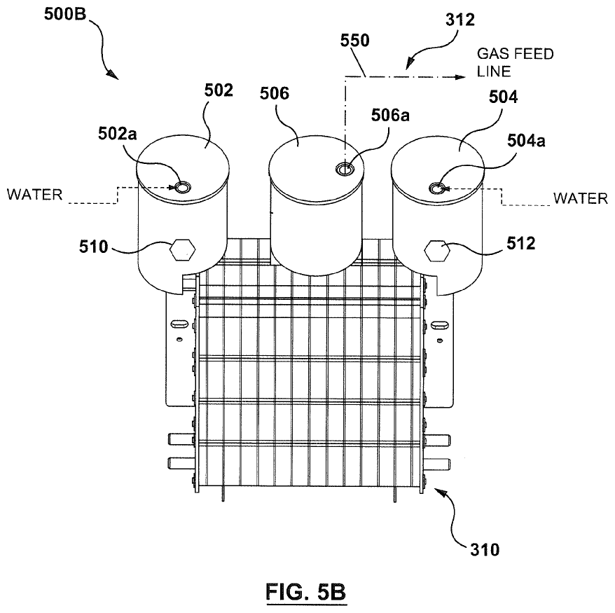

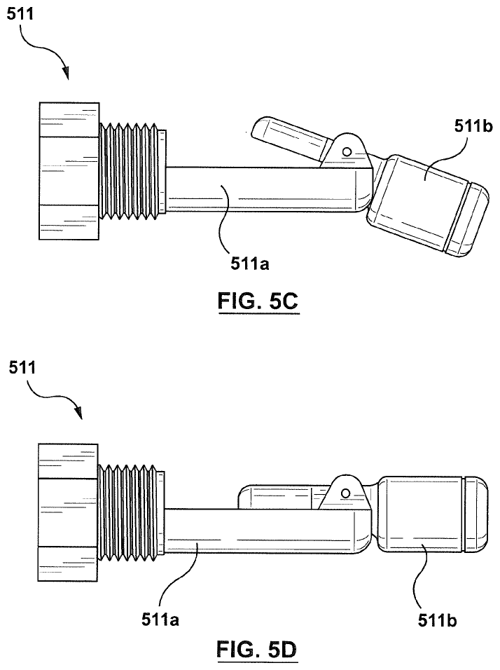

Reference is now made to FIGS. 5A and 5B, which schematically illustrate a perspective view of an example embodiment of a reactor cell and tank system assemblies 500A and 500B, respectively. FIG. 5A illustrates the reactor cell and tank system assembly 500A according to one example. FIG. 5B illustrates the reactor cell and tank system assembly 500B according to another example.

FIG. 5A illustrates the reactor cell and tank system assembly 500A as including the tank system 312 and reactor cell assembly 310. The tank system 312 includes three containers 502, 504, and 506. The containers 502 and 504 are in fluid communication with the reactor cell assembly 310. Containers 502 and 504 receive, through inlets 502a and 504a, electrolyte solution from the solution pump 390. The electrolyte solution is supplied by the containers 502 and 504 to the reactor cell assembly 310 for the purposes of electrolysis. Container 502 and 504 also collect gas generated by the reactor cell assembly 310 as a byproduct of electrolysis. As explained in further detail herein, gas collected by containers 502 and 504 may be channeled to container 506. In an application where an internal combustion engine is coupled to the reactor system 313, the gas in container 506 may be transferred to said internal combustion engine via gas outlet 506a. In various cases, the gas is transferred to the internal combustion engine through a gas feed line 550, which is connected to an air intake of the internal combustion engine. The gas feed line 550 may be, for example, a connecting tube.

Containers 502 and 504 may each contain level sensors 510 and 512, respectively. The level sensors 510 and 512, each being analogous to level sensors 360 of FIG. 3A, may detect a level of solution inside the reactor cell assembly 310. The level sensors may be, for example, float switches.

An example of a float switch that may be used as level sensors 510 or 512 is shown in FIGS. 5C and 5D. FIG. 5C and FIG. 5D show the float switch 511 as having a main body portion 511a, and a bulb portion 511b. The bulb portion 511b is pivotally mounted to the main body portion 511a. FIG. 5C shows the float switch 511 in an un-triggered state where the bulb 511a is hanging below the main body portion 511a along a horizontal axis. FIG. 5D shows the float switch 511 in a triggered state where the bulb 511a is pivoted upwards such that it is now horizontally aligned with the main body portion 511a. The float switch may be triggered when the solution inside of the reactor cell assembly 310 rises to at least the level of the float switch so as to buoy up the bulb 511a into horizontal alignment with the main body portion 511b (e.g., FIG. 5D).

Referring back to FIG. 5A, the level sensors 510 and 512 may include a micro-switch which is activated when the level sensors are triggered. The activated micro-switch may be configured to transmit a sensor signal 312a to the control system 301. In some cases, when the sensor signal 312a is received by the control system 301, the control system 301 may determine that the reactor cell assembly 310 is filled with sufficient volume of solution and is prepared to carry out the electrolysis process. In these cases, the control system 301 may direct the solution pump 390 to cease supplying solution to the tank system 312. The control system 301 may also direct the ECU 305 to activate one of the reactor relays 304-309 in order to begin supplying power to the reactor cell assembly 310.

FIG. 5B shows a reactor cell and tank system assembly 500B according to another example. The reactor cell and tank system assembly 500B includes all of the elements of the reactor cell and tank system assembly 500A. However, the assembly 500B includes level sensors 510 and 512 which are positioned at a lower height in the containers 502 and 504, respectively, than the level sensors 510 and 512 in assembly 500A.

As the volume of containers 502 and 504 remains constant, the lower position of the level sensors in the assembly 500B results in the reactor cell assembly 310 receiving less solution prior to triggering the level sensors. As a result, the lower positon of the level sensors in assembly 500B results in the reactor cell assembly 310 performing electrolysis on a lower volume of solution. That is, the reactor assembly 310 requires a lower supply of solution to perform electrolysis. Further, in colder weather, the lower volume of solution in reactor cell assembly 310 of assembly 500B may be heated more quickly than the higher volume of solution in reactor cell assembly 310 of assembly 500A.

The lower position of the level sensors in assembly 500B also results in the containers 502 and 504 receiving less solution before the level sensors are triggered. The lower volumes of solution received in containers 502 and 504 may reduce the head pressure on solution inside of the reactor cell assembly 310. Head pressure refers to the resistance faced by the gas present inside the reactor cell assembly 310.

In an example embodiment, the level sensors 510 and 512 in assembly 500A are positioned approximately 2.25 inches from the top lid of containers 502 and 504, and the level sensors 510 and 512 in assembly 500B are positioned 3.25 inches from the top lid of containers 502 and 504. The lower position of the level sensors in assembly 500B, as compared to assembly 500A, results in approximately 400 ml less of solution accumulating in the reactor cell assembly 310 before the level sensors are triggered.

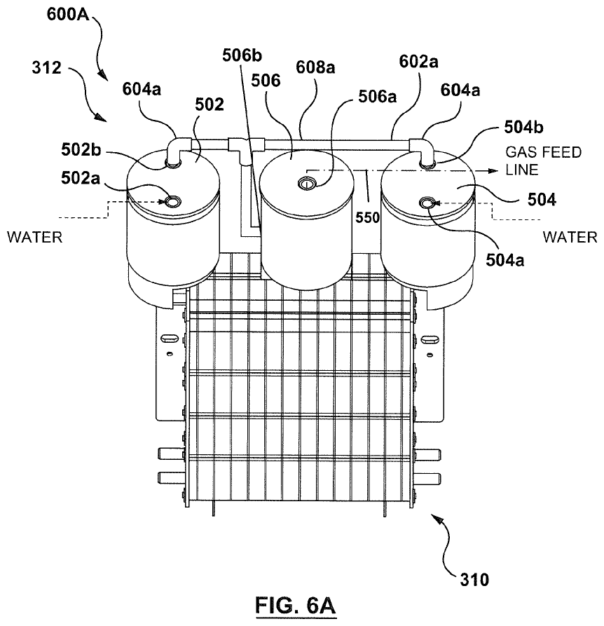

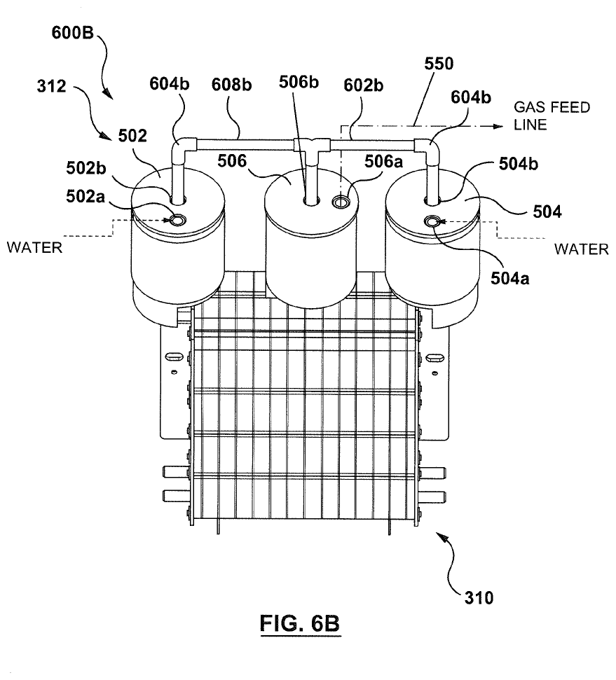

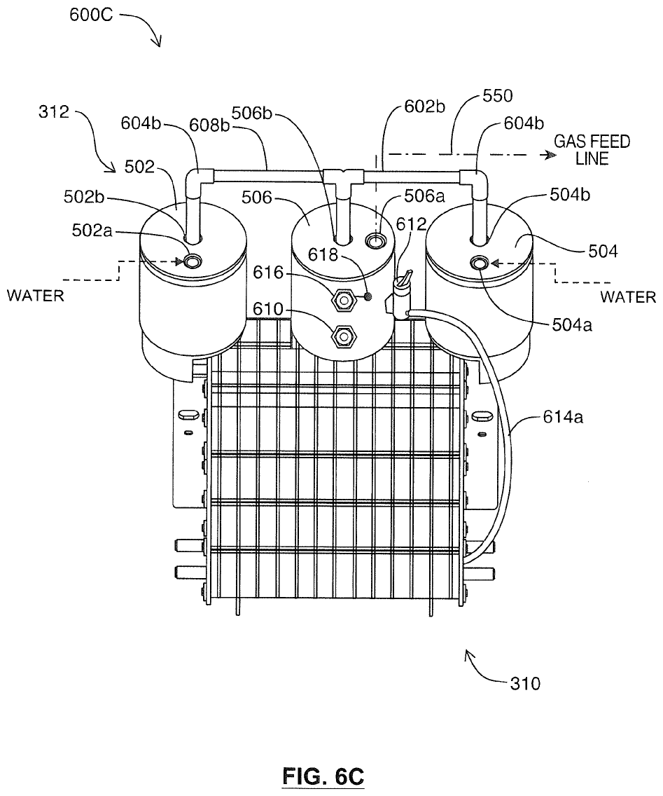

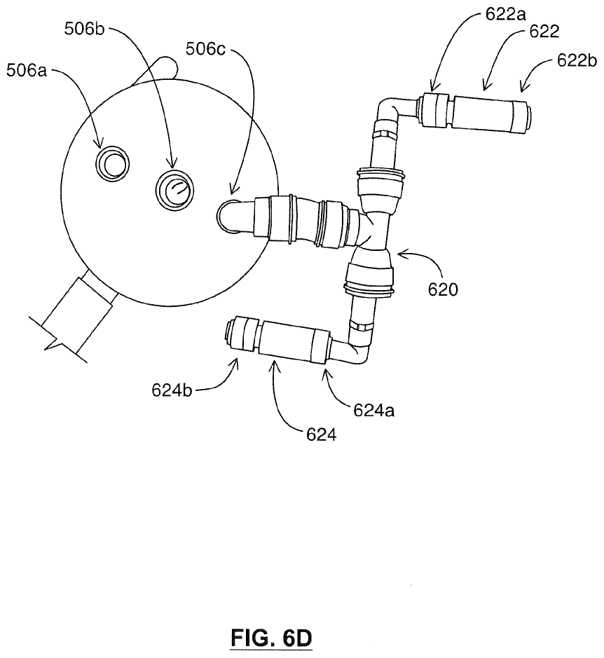

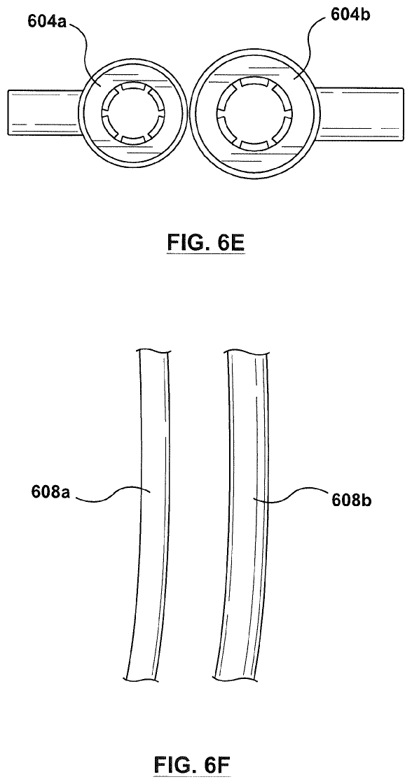

Reference is now made to FIGS. 6A and 6B, which show schematically perspective views of further example embodiments of reactor cell and tank system assemblies 600A and 600B, respectively. FIG. 6A illustrates the reactor cell and tank system assembly 600A according to one example. FIG. 6B illustrates the reactor cell and tank system 600B assembly according to another example.

FIG. 6A shows the reactor cell and tank system assembly 600A as including the reactor cell assembly 310 and tank system 312. The tank system 312 includes containers 502 and 504, in fluid communication with the reactor cell assembly 310. The containers 502 and 504 include inlets 502a and 504a to receive water (or other electrolyte solution) from the solution pump 390. Solution from containers 502 and 504 is fed into the reactor cell assembly 310, and is used for electrolysis. Gas generated by the reactor cell assembly 310, as a byproduct of electrolysis, is collected back into each of containers 502 and 504.

Gas received by containers 502 and 504 can be channeled to container 506 through gas plumbing 602a. As illustrated, gas plumbing 602a is connected to gas outlets 502b and 504b, of containers 502 and 504, respectively, and gas inlet 506b of container 506. Accordingly, gas can exit each of containers 502 and 504 through gas outlets 502b and 504b, respectively, and travel to container 506 through the gas plumbing 602a. Container 506 also includes a gas outlet 506a through which gas, collected from containers 502 and 504, can exit the container 506 into the gas feed line 550. Gas feed line 550 may be a channeling medium (e.g., a tube) that channels gas from container 506 to a unit or device coupled to the reactor and tank assembly 600A. In an example case where the reactor and tank assembly 600A is connected to an internal combustion engine, the gas feed line 550 may feed gas from container 506 to an air intake of the internal combustion engine. In some cases, the suction force generated by the engine's air intake drives the flow of gas from containers 502 and 504 through gas plumbing 602a, into container 506, and through the gas feed line 550 to the internal combustion engine.

As shown, gas plumbing 602a includes gas tubes 608a interlinked by gas connectors 604a. The gas tubes 608a and gas connectors 604a may each be defined by an internal diameter. The internal diameter of gas tubes 608a and gas connector 604a can be selected to determine the volume of gas that can flow through these components at a given time instance. The internal diameter may also determine the level of resistance faced by gas flowing through these components.

FIG. 6B shows a reactor cell and tank system assembly 600B according to another example. The reactor cell and tank system assembly 600B includes all of the elements of the reactor cell and tank system assembly 600A, with the exception that reactor cell and tank system assembly 600B includes gas plumbing 602b, in replacement of gas plumbing 602a. Gas plumbing 602b includes gas tubes 608b interlinked by gas connectors 604b. The gas plumbing 602b (i.e., gas tube 608b and gas connectors 604b) has a larger internal diameter than the gas plumbing 602a of assembly 600A.

The increased diameter of gas plumbing 602b supports higher volumes of gas being channeled through the plumbing, while also reducing gas flow resistance. Gas plumbing 602b can accordingly support configurations of cell reactor assembly 310, which generate higher rates of gas per minute. In an application where an ICE is connected to the reactor cell assembly 310, the increased diameter of gas plumbing 602b supports increased gas flow to the ICE.

In some embodiments, gas plumbing 602a has an external diameter of ⅜^{th} inches, whereas gas plumbing 602b has an external diameter of 0.5 inches. The ⅛^{th} inch increase in the external diameter of gas plumbing 602b results in an increase in gas flow capacity of 125% through gas plumbing 602b as compared to the gas flow through gas plumbing 602a. FIG. 6E is a perspective view of the gas connector 604a according to FIG. 6A, and the gas connector 608b according to FIG. 6B. FIG. 6F is a perspective view of the gas tube 608a according to FIG. 6A, and the gas tube 608b according to FIG. 6B. As shown, the gas connector 604a and gas tube 608a are smaller in diameter than the gas connector 604b and gas tube 608b. For example, the gas connector 604a and gas tube 608a may have an external diameter of 0.25 inches, while the gas connector 604b and gas tube 608b may have an increased diameter of ⅜ inches. The increase diameter of gas connector 604b and gas tube 608b supports higher gas flow through the connector 604b and tube 608b.

Reference is now made to FIG. 6C, which shows a reactor cell and tank system assembly 6000 according to another example.

In addition to collecting gaseous byproducts, containers 502-506 may, in some cases, inadvertently collect solution and KOH from the reactor cell assembly 310. For example, in some cases, the containers 502-506 may collect electrolyte solution and KOH due to large suction forces being generated by an internal combustion engine connected to the reactor and tank assembly 600C. For example, in cases where an internal combustion engine is operated at high speeds (e.g., high RPM), or the engine turbocharger is activated, the engine may demand larger supplies of air. Accordingly, the extra supply of air may be drawn through the engine's air intake, which can generate larger suction forces through the gas feed line 550, which is connected to the air intake. The suction forces may, in turn, generate a build-up of negative pressure inside of the containers 502-506, which can draw electrolyte solution and KOH out of the reactor cell assembly 310 and into the tank system 312.

Electrolyte solution and KOH may also collect inside of containers 502-506 as a result of condensation of gas vapors generated by electrolysis inside of the reactor cell assembly 310. In particular, with each switch of cell configuration inside of the reactor cell assembly 310, the temperature inside of the reactor cell assembly 310 may increase, resulting in a larger quantity of vapors in the gas being formed. In some cases, the gas vapors may condense inside of the containers 502-506, resulting in accumulation of solution and KOH inside of each container. The problem of condensing gas vapors is accentuated when the reactor and cell assembly 6000 is operating in warmer ambient temperatures.

In various cases, accumulation of solution and KOH inside of containers 502-506, which result from large suction forces or condensation of gas vapors, may in turn, result in flooding of a unit or device, which is connected to the reactor and tank assembly 6000. For example, the suction force generated by an internal combustion engine may draw the solution and KOH out of container 506, through the gas feedline 550, to the internal combustion engine, and damaging the engine.

In some embodiments, in order to prevent accumulation of solution and KOH inside of containers 502-506, and consequent overflow from container 506 to a connected unit or device, container 506 can include an overflow sensor 610. The overflow sensor 610 is analogous to the overflow sensor 365 of FIG. 3A. The overflow sensor 610 provides a safety check feature by ensuring that the level of solution and KOH inside of container 506 does not exceed a predetermined threshold height.

In some embodiments, container 506 also includes a pump 612, which is in fluid communication with the inner volume of container 506. Pump 612 is analogous to pump 380 of FIG. 3A. In cases where the overflow sensor 610 is activated, pump 612 can pump excess solution and KOH out of container 506 and back into the reactor cell assembly 310. In some cases, a channeling tube 614 may be provided to channel excess solution and KOH, pumped out of container 506, back into the reactor cell assembly 310. In particular, the use of pump 612 avoids the necessity of shutting down the reactor and cell assembly 6000 and manually removing and emptying the container 506, which can result in excessive downtime for the system.

In various cases, pump 612 can be activated by the control system 301. To activate pump 612, the overflow sensor 610 may include a micro switch, which upon activation, transmits a sensor signal 312b to the control system 301. The control system 301 receives and processes the sensor signal 312b, and directs the pump 612 to begin pumping solution and KOH out of the container 506 and into the channeling tube 614. In some cases, the channeling tube 614 can channel the excess solution and KOH from the container 506, to a bottom portion of the reactor cell assembly 310. In particular, this may have the advantage of aiding in the proper re-mixing of KOH with electrolyte solution already present inside of the reactor cell assembly 310. In cases where the electrolyte solution comprises water, the higher density of KOH relative to water may further justify injection from the bottom of the reactor cell assembly 310, rather than the top, to assist in proper re-mixing.

In various cases, pumping by pump 612 can occur for a duration of five seconds, which may be sufficient time to allow pumping of the entire volume of the container 506 back into the reactor cell assembly 310. Once the pumping is complete, and the level of solution and KOH has returned to below the height of the overflow sensor 610, the control system 302 can de-activate the pump 612.

It will be appreciated that by pumping solution and KOH back into the reactor assembly 310, KOH can be re-used in the electrolysis process. Further, pumping solution and KOH back into the reactor cell assembly 310 also ensures that the concentration of KOH inside of the reactor cell assembly 310 is not diluted, and is otherwise maintained at a constant level. In cases where the electrolyte solution is water, dilution of the KOH solution can increase the boiling point of water inside of the reactor cell assembly 310. This, in turn, may result in an increase in the volume of gas vapors generated by the cell assembly 310, and accumulation of further KOH inside of the containers 502-506 if the gas vapors condense. Lower concentrations of KOH inside of the reactor cell assembly 310 also reduces the freezing point of water, making the water more prone to freezing during operation of the reactor system in colder ambient temperatures. Accordingly, this can impair the function of the reactor system during operation in colder temperatures. Still further, at lower concentrations of KOH, the conductivity of the liquid mix inside of the reactor cell assembly 310 is reduced, which can result in a decrease in gas production, and a consequent reduction in the efficiency of the reactor and cell assembly 600C.

In some embodiments, container 506 may include a secondary overflow sensor 616. The secondary overflow sensor 616 can be analogous to the primary overflow sensor 610, but may be located closer to the gas outlet 506a. The secondary overflow sensor 616 can provide a fail-safe back-up to preventing overflow of solution and KOH inside of the container 506. For example, the secondary overflow sensor 616 may be necessary where solution and KOH is flowing into the container 506 at a rate faster than the rate at which solution and KOH is being pumped out of container 506 by pump 612. In other cases, the secondary overflow sensor 616 may be necessary where the primary sensor 610 and/or pump 612 malfunction.

Where the secondary overflow sensor 616 is activated, the secondary overflow sensor 616 can transmit a signal 312b to the control system 301. The control system 301 can process the signal and, in response, shut down the reactor and tank system 6000. Control system 301 can shut down the reactor and tank system 6000 by transmitting a control signal 318, to the ECU, to de-activate all reactor relays 304-309. By de-activating the reactor relays, no positive voltage is applied to the reactor cell assembly 310 and the electrolysis process is stopped.

In some cases, the container 506 may not include a primary overflow sensor 610 or pump 612, but may only include the secondary overflow sensor 616. In these cases, the reactor and tank assembly 6000 is automatically shut down once the secondary overflow sensor 616 is activated.

In some embodiments, the container 506 may also include a visual indicator 618. The visual indicator 618 can be, for example, an LED light. The visual indicator 618 can be located on the exterior of the container 506, or otherwise, at any other location external to the container 506. In some cases, the container 506 may comprise an at least partially transparent exterior, and the visual indicator 618 can be located inside of the container 506. The visual indicator 618 can connect (e.g., electrically connect) to the secondary overflow sensor 616 such that the visual indicator 618 is activated when the secondary overflow sensor 616 is activated. In other cases, the visual indicator 618 can connect to the control system 301, and may be activated by the control system 301 when the control system 301 receives a signal 312b from the secondary overflow sensor 616. When the visual indicator 618 is activated, this can indicate to a user that the container 506 is overflowing with solution and KOH, and that manual removal and emptying of the container 506 is necessary.

In some embodiments, the secondary overflow sensor 616 may not automatically shut down the reactor system 6000 upon activation, but may only activate the visual indicator 618. Once the visual indicator 618 is activated, a user may manually shutdown the reactor and tank assembly 6000 and empty the container 506. In still other cases, the visual indicator 618 may connect to the primary overflow sensor 610.

Reference is now made to FIG. 6D, which shows schematically a top perspective view of the container 506 of the reactor cell and tank system assembly 6000, according to some further example embodiments.

As shown, container 506 includes a gas outlet 506a and gas inlet 506b. The gas outlet 506a connects to a gas feed line 550, which channel gas to a unit or device connected to the reactor and tank assembly 6000 (e.g., an internal combustion engine). Gas inlet 506b is used for receiving gas from container 502 and 506 through gas plumbing 602a or 602b.

In the illustrated embodiment, container 506 also includes an additional outlet 506c. As illustrated, outlet 506c can receive a tube connector assembly 620, which is coupled to a first pressure relief valve 622 and a second pressure relief valve 624.

First pressure relief valve 622 can be used for preventing buildup of negative pressure inside the reactor and tank assembly 6000. In various cases, negative pressure can result from large suction forces being generated by an internal combustion engine connected, via gas feed line 550, to the container 506. Negative pressure can place the reactor and tank assembly 6000 under stress by generating large pressure differences between the inside the reactor and tank assembly 6000, and the outside of the reactor and tank assembly 6000 (e.g., the atmospheric pressure). In some cases, negative pressure inside of the reactor and tank assembly can also cause solution and KOH to overflow from the reactor cell assembly 310, into the tank assembly 312 and into the engine. As shown, the first pressure relief valve 622 can include an inlet end 622a in communication with the container 506 through the connector assembly 620, and an opposed outlet end 622b. When a threshold build-up of negative pressure is detected inside of the container 506 at the inlet end 622a, the pressure relief valve 622 can open to permit an influx of air to enter the container 506. The influx of air equalizes the pressure inside of the reactor and tank assembly 600C to the atmospheric pressure outside of the reactor and tank assembly. In some embodiments, the first pressure relief valve 622 can have a threshold pressure setting of 0.3 PSI.

Second pressure relief valve 624 can be used to prevent build-up of positive pressure inside of the reactor and tank assembly 600C. Build-up of positive pressure can result, for example, from blockage of the gas outlet 506c of container 506 due to either physical restraint or gradual buildup of frozen moisture. Build-up of positive pressure inside of the reactor and tank assembly 6000 can result in leakage, which may cause the assembly to become non-operational. As shown, the second pressure relief valve 624 also includes an inlet end 624a in communication with the container 506 through the connector assembly 620, and an opposed outlet end 624b. When a threshold build-up of positive pressure is detected inside the container 506 at the inlet end 624a, the outlet end 624a can open to permit air to exit the container 506 and equalize the pressure inside of the reactor and tank assembly 6000 with the atmospheric pressure outside of the assembly. In some embodiments, the second pressure relief valve 624 can have a threshold pressure setting of 5.0 PSI.

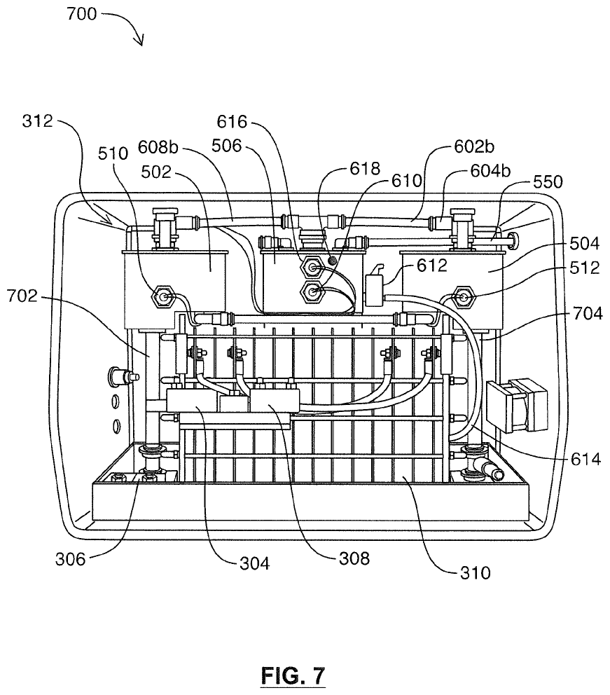

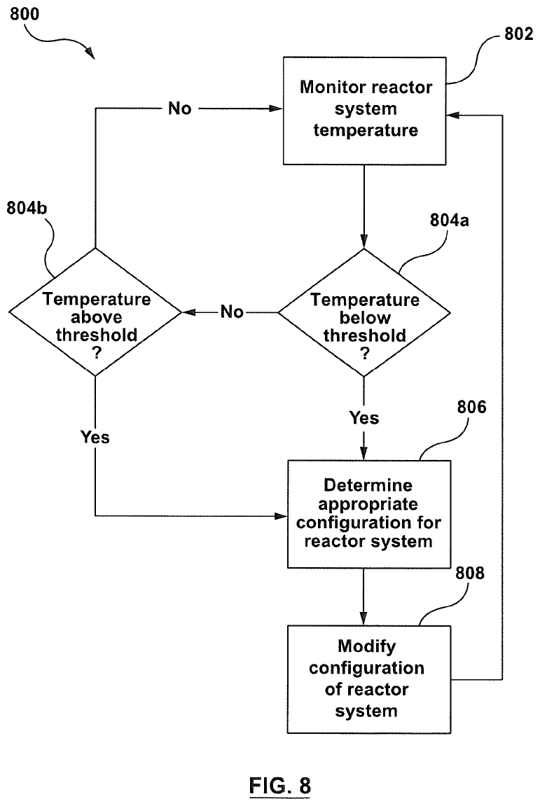

FIG. 7 illustrates a perspective view of a reactor system 700 according to an example embodiment. Reactor system 700 is analogous to reactor system 313 of FIGS. 3A and 3B. Reactor system 700 includes the tank system 312 and the reactor cell assembly 310. The tank system 312 is in fluid communication with the reactor cell assembly 310 to supply the reactor cell assembly 310 with electrolyte solution.

As illustrated, the electrolyte solution is supplied from the tank system 312 to the reactor cell assembly 310 through plumbing 702 and 704, which connect the tank system 312 to inlets located in the left and right sides of the reactor cell assembly 310 (not shown). The tank system 312 includes containers 502, 504 and 506. The containers 502 and 504 include level sensors 510 and 512, respectively. In the illustrated embodiment, the level sensors 510 and 512 are located 3.25 inches from the top lid of the containers 502 and 504.

Container 506 can include a primary overflow sensor 610, a secondary overflow sensor 616, a visual indicator 618, and a pump 612 connecting the container 506 to the reactor cell assembly 310 via channel tube 614. The gas plumbing 602b channels gas collected inside of containers 502 and 504 to container 506. Gas feed line 550 channels gas from container 506 to a device or unit connected to the reactor cell assembly 310.

In applications where the reactor cell assembly 310 is connected to an internal combustion engine, the gas feed line 550 can channel the byproduct gases (e.g. hydrogen and oxygen gases) to the internal combustion engine.

The reactor system 700 also includes the reactor cell assembly 310, which includes the reactor relays 304, 306, 308 and 309 coupled to electrolytic cells inside of the reactor cell assembly 310 (reactor relay 309 is hidden from view). The reactor relays 304, 306, 308 and 309 of FIG. 7 are similar in structure and operation of reactor relays 304, 306, 308 and 309 of FIGS. 3A-3C and 4A-4D.

Reference is now made again to both FIGS. 2A and 2B, which illustrate the example applications of the electrolytic reactor platform 300 of FIG. 3A, and electrolytic reactor 700 of FIG. 7, and a method of operating the same. In particular, as previously discussed, FIG. 2A illustrates a block diagram of a fuel management system 200A according to one example. FIG. 2B illustrates a block diagram of a fuel management system 200B according to another example.

The fuel management system 200A of FIG. 2A includes the internal combustion engine (“ICE”) 208, the reactor system 313, and the control system 301. The various components of fuel management system 200A are connected over a network 202.

Network 202 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these. Network 202 may also include a storage medium, such as, for example, a CD ROM, a DVD, an SD card, an external hard drive, a USB drive, etc. Network 202 may also include a storage medium, such as, for example, a CD ROM, a DVD, an SD card, an external hard drive, a USB drive, etc.

Reactor system 313 is any reactor system configured to carry out the process of electrolysis, and is analogous to the reactor systems 313 of FIGS. 3A and 3B in structure and functionality. ICE 208 is a combustion engine configured to carry out the process of combustion of a carbon-based fuel. In the illustrated embodiment, the ICE 208 is configured to carry out the process of combustion for a mixture of carbon-based fuel with hydrogen and oxygen gases received from the reactor system 313. The embodiment of FIG. 2A is discussed in further detail with reference to the embodiment of FIG. 2B below.

FIG. 2B illustrates the fuel management system 200B according to a further example embodiment. As shown, the reactor system 313 may be configured to supply an air-intake stream of the ICE 208 with hydrogen (H₂) and oxygen (O₂) gases. The hydrogen and oxygen gases supplied to the ICE 208 are generated by the reactor system 313.

An engine control module (“ECM”) 206 may be connected to the ICE 208 in order to monitor operating conditions. The operating conditions of the ICE 208 which are monitored by the ECM 206 include, but are not limited to, odometer information, engine speed, fuel consumption, fuel rate, mass air pressure, mass air flow, mileage, distance, fuel rate, exhaust temperature, NOₓ levels, CO₂ levels, O₂ levels, engine instantaneous fuel economy, engine average fuel economy, engine inlet air mass flow rate, engine demand percent torque, engine percent load at current speed, transmission actual gear ratio, transmission current gear, engine cylinder combustion status, engine cylinder knock level, after treatment intake NOₓ level preliminary failure mode identifier (FMI), drivetrain information, vehicle speed and GPS location, etc.

In at least some embodiments, the operating conditions monitored by the ECM 206 may be communicated to the control system 301 via the engine data signal 314. The control system 301 may use the information contained in the engine data signal 314 to make one or more determinations in respect of the operation of various components of the fuel management system 200B. For example, the control system 301 may determine from the information in the engine data signal 314 that the ICE 208 requires a higher or lower input of hydrogen and oxygen gases. The control system 301 may then transmit a control signal 318 instructing the reactor system 313 to vary a configuration of the reactor system in order to increase or decrease the production rate of the hydrogen and oxygen gases.

In cases where the ICE 208 does not include an ECM 206 or the ECM 206 does not provide the necessary data, other sensors or devices may connect to the ICE 208 or other parts of the vehicle in order to monitor engine parameters. Engine-parameters received from these sensors or devices can be used by the control system 301 to determine the performance of the ICE 208.

The control system 301 may also receive data from the monitoring system 350 connected to the reactor system 313. For example, the monitoring system 350 may include one or more temperature sensors 355, which may be externally located around, or near, the reactor system 313 in order to measure an ambient temperature of the reactor system 313. The temperature sensors 355 may also be disposed internally within the reactor system 313.

The temperature sensors 355 may be configured to transmit temperature measurements to the control system 301 through temperature signals 316a. The control system 301 may use the information contained in the temperature signals 316a to make determinations with respect to the operation of various components of the fuel management system 200B. For example, the control system 301 may determine from the temperature signals 316a that the reactor system 313 is operating in temperatures that are below the ideal operating temperature range. The control system 301 may then transmit a control signal 318 instructing the reactor system 313 to vary a configuration of the reactor system with a view to heating the reactor system to the ideal operating temperature range.

In some embodiments, the temperature sensors 355 may be preconfigured to transmit temperature measurements to the control system 301 at predetermined time intervals, or at a predetermined frequency. In other cases, the temperature sensors 355 may transmit temperature measurements to the control system 301 in response to temperature request signals 316b sent by the control system 301 to the temperature sensors 355.

In other cases, the control system 301 may receive current consumption data via current signals 370a generated by current sensors 370. The control system 301 may similarly use the information contained in the current signals 370a to make determinations with respect to the operation of various components of the fuel management system 200B. For example, the control system 301 may determine from the current signal 370a that the reactor system 313 is generating low rates of gas production and/or operating at a below ideal temperature range. The control system 301 may then accordingly transmit a control signal 318 instructing the reactor system 313 to vary a configuration of the reactor system with a view to increasing the gas production rate and/or heating the reactor system to an ideal temperature range

In some cases, the control system 301 may be located remotely from the ICE 208 and reactor system 313, and operated by an operator. The operator may be able to control the various components of the fuel management systems 200B by interacting with a user interface of the control system 301. For example, the control system 301 may include a user interface which informs the operator of the ambient temperature around or within the reactor system 313 (i.e. using information from the temperature signals 316a). The operator may then select an appropriate configuration for the reactor system 313 through the user interface. The control system 301 may apply the selected configuration to the reactor system 313 through the control signal 318. In other cases, the temperature sensors 355 or current sensors 370 may not be operational, in which case the operator may input a temperature or current value into the user interface of the control system 301. The control system 301 may then determine the appropriate cell configuration for reactor system 313 based on the inserted temperature or current values.

Other sensors may be located around, or within, the reactor system 313. These sensors may relay to the control system 301 data in respect of water tank level, electrolyte level, supplied electrical voltage, supplied electrical current, water tank temperature, reactor temperature, reactor leakage, water pump, gas flow, relative humidity, conductivity of electrolyte, resistance of electrolyte, and concentration of electrolyte.

Reference is next made to FIG. 8, illustrating an example embodiment for a method 800 for modifying a configuration of the reactor system 313 based on the sensed temperature associated with the reactor system 313. The method 800 may be carried out by the control system 301.

At 802, the control system 301 receives information from one or more temperature sensors 355 with respect to the ambient temperature associated with the reactor system 313. In some cases, the temperature measured by the temperature sensors 355 may be the temperature inside the reactor system 313. In some other cases, the temperature measured by the temperature sensors may be the temperature inside the reactor cell assembly 310.

At 804a, the control system 301 makes a determination as to whether the temperature associated with the reactor system 313 is below a predefined threshold (i.e. below an ideal operating temperature range). If this is the case, at 806 the control system 301 determines an appropriate configuration for the reactor system 313. The appropriate configuration may be that which sufficiently heats the reactor system 313 to raise the temperature to the ideal range. For example, if the ambient temperature associated with the reactor system 313 is measured below 20 degrees Celsius, the control system 301 may determine that the appropriate configuration for reactor system 313 is a ten active cell configuration, as shown in FIG. 4B. Alternatively, if the ambient temperature associated with the reactor system 313 is measured below 0 degrees Celsius, the control system 301 may determine that the appropriate configuration for reactor system 313 is an eight active cell configuration or a six active cell configuration, as shown in FIGS. 4C and 4D, respectively.

At 808, the control system 301 directs the ECU 305 to modify the configuration of the reactor system 313 by de-activating and/or activating relay elements 304-309. For example, if at 806, the control system 301 determines that the appropriate configuration for reactor system 313 is a ten active cell configuration, the control system 301 can direct the ECU 305 to cause the de-activation the first reactor relay 304 (if it was previously activated), and activation the second reactor relay 306. If at 806, the control system 301 determines that the appropriate configuration for reactor system 313 is an eight active cell configuration, the control system 301 can direct the ECU 305 to cause the de-activation of either the first reactor relay 304 or the second reactor relay 306 (as the case may be), and activation of the third reactor relay 308. If none of the reactor relays was previously activated, the ECU 305 will directly activate the relevant reactor relay. If at 806, the control system 301 determines that the appropriate configuration for reactor system 313 is a six active cell configuration, the control system 301 can direct the ECU 305 to cause the de-activation of either the first reactor relay 304, second reactor relay 306, or third reactor relay 308 (as the case may be), and activation of the fourth reactor relay 309. If none of the reactor relays was previously activated, the ECU 305 will directly activate the relevant reactor relay. The modification of the reactor system 313 to a lower number of activated cells will result in the reactor system 313 warming-up to the desired temperature range (i.e. the ideal operating temperature range).

Alternatively, at 804a, if it is determined that the temperature associated with the reactor system 313 is not below the predetermined threshold, the control system 301 determines if the temperature is above a predetermined threshold at 804b. For example, in some cases, the reactor system 313 may be generating excess heat because of increased gas production. If this is the case, the control system 301 determines the appropriate configuration for the reactor cell assembly 310 at 806. For instance, if the reactor system 313 is operating at a six or eight active cell configuration and generating excess heat, the control system 301 may determine that a ten active cell configuration, as shown in FIG. 4B, or a twelve active cell configuration, as shown in FIG. 4A, is more appropriate.

At 808, the control system 301 directs the ECU 305 to modify the configuration of reactor system 313 by de-activating and/or activating relay elements 304-309. For instance, the control system 301 may direct the ECU 305 to cause the de-activation of the third reactor relay 308 or fourth reactor relay 309 (if it was previously activated), and activation of either the first reactor relay 304, or the second reactor relay 308 to modify the configuration to a twelve active cell configuration or a ten active cell configuration, respectively. The modification of the configuration of the reactor system 313 to a higher number of active cells will help in cooling down the reactor system 313 to a suitable temperature.

If the control system 301 does not determine that the temperature associated with the reactor system 313 is above a predetermined threshold at 804b, the process returns to 802 where the control system 301 continues to receive temperature measurements from one or more temperature sensors 355.

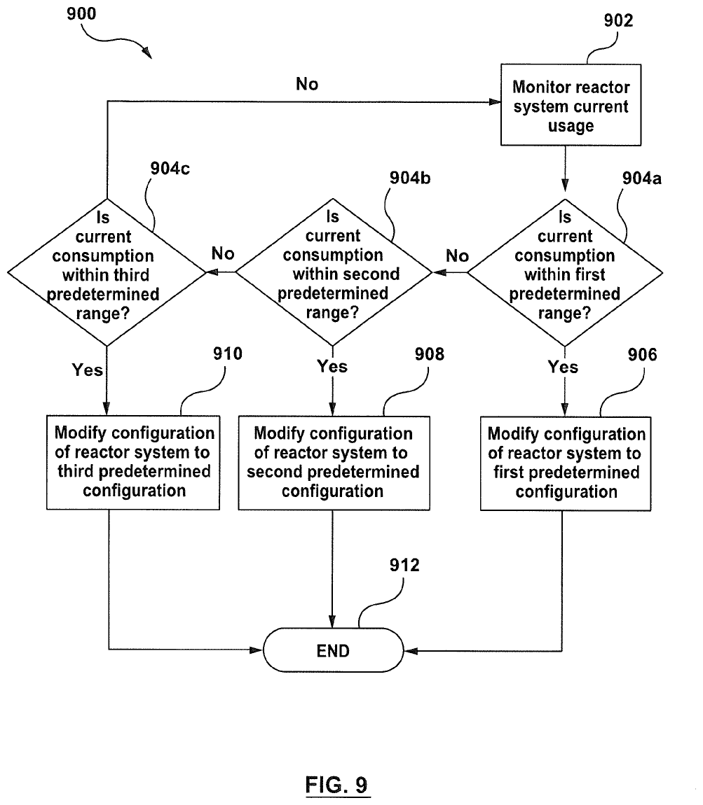

Reference is next made to FIG. 9, illustrating an example embodiment for a method 900 for modifying a configuration of the reactor system 313 based on the sensed current consumption of the reactor system 313. The method 900 may be carried out by the control system 301.

At 902, the control system 301 receives current consumption data from a monitoring system, such as the monitoring system 350. The monitoring system 350 may include one or more current sensors 370 configured to monitor the current consumption by the reactor system 313.

At 904a, the control system 301 uses the current consumption data to determine whether the current consumption level is within a first predetermined range. In an example embodiment, the first predetermined range may be a range of current consumption that is the ideal range of current consumption. By way of a non-limiting example, the first predetermined range of current consumption may be between 15 A and 20 A. This may indicate that the reactor system 313 is operating at ideal temperature, since cooler temperatures slow down the current consumption of the reactor system 313.

If at 904a, the current consumption is determined to be within the first predetermined range, at 906, the control system 301 modifies the configuration for the reactor system 313 to a first predetermined configuration. By way of a non-limiting example, the first predetermined configuration may be a twelve active cell configuration as shown in FIG. 4A. The control system 301 modifies the reactor system 313 to the twelve active cell configuration by directing the ECU 305 to activate the first reactor relay 304.

Alternatively, at 904a, if it is determined that the current consumption of the reactor system 313 is not within the first predetermined range, the control system 301 determines at 904b if the current consumption is within a second predetermined range, where the second predetermined range of current consumption is lower than the first predetermined range. By way of a non-limiting example, the second predetermined range of current consumption may be between 6 A and 10 A. This may indicate that the reactor system 313 is operating at below-ideal temperatures, or cooler temperatures, since the current consumption of the reactor system 313 decreases as the temperature decreases. In addition, decrease in the current consumption by the reactor system 313 also decrease the process of electrolysis, and accordingly, the rate of gas production.

If the current consumption is found to be within the second predetermined range at 904b, the process proceeds to 908, where the configuration of the reactor system 313 is modified to a second predetermined configuration. The second predetermined configuration is a configuration with reduced number of active cells than the first predetermined configuration. By way of a non-limiting example, the second predetermined configuration may be a ten active cell configuration, as shown in FIG. 4B. By decreasing the number of active cells, the current consumption per cell increases, thereby increasing the process of electrolysis in the reactor system 313. This results in increased rate of gas production, which results in increasing the heat in the reactor system 313. Accordingly, the temperature of the reactor system 313 increases, which subsequently increases the current consumption of the reactor system 313.

The control system 301 modifies the reactor system 313 to the ten active cell configuration by directing the ECU 305 to activate the second reactor relay 306. In cases where the first reactor relay 304 is previously activated, the control system 301 directs the ECU 305 to de-activate the first reactor relay before directing the ECU 305 to activate the second reactor relay 306.

If, however, at 904b, it is determined that the current consumption is not within the second predetermined range, the process proceeds to 904c, where it is determined if the current consumption is within a third predetermined range, with the third predetermined range being lower than the second predetermined range. By way of a non-limiting example, the third predetermined range of current consumption may be between 0 A and 5 A. Lower than ideal current consumption by the reactor system 313 may indicate that the reactor system 313 is operating at very cold temperatures. As well, this may result in a substantially reduced rate of gas production by the reactor system 313.

If the current consumption is found to be within the third predetermined range at 904c, the process proceeds to 910, where the configuration of the reactor system 313 is modified to a third predetermined configuration. At 910, the third predetermined configuration is a configuration with reduced number of active cells than the second predetermined range. By way of a non-limiting example, the third predetermined configuration may be an eight active cell configuration, as shown in FIG. 4C, or a six active cell configuration as shown in FIG. 4D. The control system 301 may accordingly modify the reactor system 313 to the eight active cell configuration by directing the ECU 305 to activate the third reactor relay 308. In other cases, the control system 301 may modify the reactor system 313 to the six active cell configuration by directing the ECU 305 to activate the fourth reactor relay 309. In cases where the first reactor relay 304 or the second reactor relay 306 are previously activated, the control system 301 can first direct the ECU 305 to deactivate the first or second reactor relay (as the case may be) before directing the ECU 305 to activate the third reactor relay 308 or fourth reactor relay 309.

By decreasing the number of active cells to eight cells or six cells, the current consumption per cell increases, thereby increasing the process of electrolysis in the reactor system 313. This results in increased rate of gas production, which results in increasing the heat in the reactor system 313. Accordingly, the temperature of the reactor system 313 increases, which subsequently increases the current consumption of the reactor system 313.

If, however, the current consumption of the reactor system 313 is not determined to be within the third predetermined range at 904c, the process returns to 902, where the current consumption by the reactor system 313 continues to be monitored.

In any of the cases (906, 908, 912), once the control system 301 modifies the configuration of the reactor cell assembly 313, the method 900 ends at 912.

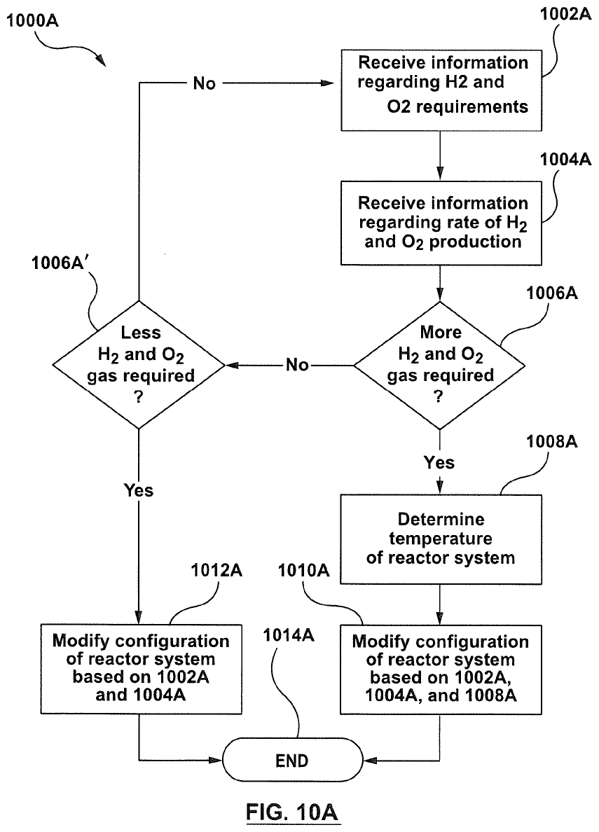

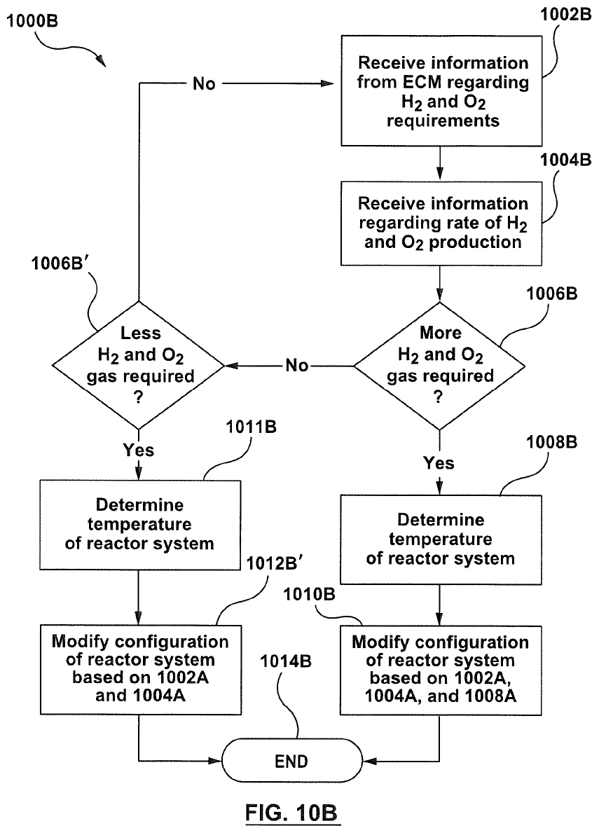

Reference is next made to FIG. 10A, which illustrates an example embodiment for a method 1000A for modifying a configuration of the reactor system 313 according to the hydrogen and oxygen demands of an ICE connected to the reactor system 313. The method 1000A may be carried out by the control system 301.

At 1002A, the control system 301 receives information with respect to the hydrogen gas and oxygen gas demands of the ICE 208. Once the gas demands of the ICE 208 are known, the process of electrolysis carried out by the reactor system 313 can be modified to accommodate such demands. In some cases, the operating conditions of the ICE 208 are received by the control system 301, where the operating conditions are analyzed and processed to determine the gas demands of the ICE 208. The operating conditions of the ICE 208 may be received from the ECM 206. In some other cases, the gas demands of the ICE 208 are received from an external source.

At 1004A, the control system 301 also receives information regarding the current rate of gas production of the reactor system 313. For example, the control system 301 may receive current consumption information from the current sensors 370. The current consumption information may then be used by the control system 301 to determine the current rate of gas production by the reactor system 313. The control system 301 may receive the current consumption information by way of the monitoring system 350, which may include one or more current sensors 370.

At 1006A, the control system 301 makes a determination as to whether the gas production rate of the reactor system 313 should be increased or decreased in order to meet the hydrogen and oxygen gas demands of the ICE 208. The determination at 1006A may be made using the information gathered at 1002 and 1004A.

If the control system 301 determines at 1006A that the ICE 208 requires a further input of hydrogen and oxygen gas, then at 1008A the control system 301 determines the current temperature of the reactor system 313. For example, the control system 301 can determine the current temperature of the reactor system 313 based on ambient temperature information received from temperature sensors 355. Alternatively, or in addition, the control system 301 can also determine the relative temperature of the reactor system 301 using current consumption information received from current sensors 370.

At 1010A, the control system 301 modifies the configuration of the reactor system 313 based on the gas requirements of the ICE 208 (as determined at 1006A), the current rate of gas production of the reactor system 313 (as determined at 1004A), and the current temperature of the reactor system 313 (as determined at 1008A). For example, if the control system 301 determines that the ICE 208 requires a further input of hydrogen and oxygen which is not being currently supplied by the reactor system 313, the control system 301 may determine that the appropriate configuration for the reactor system 313 is either a ten active cell configuration, as shown in FIG. 4B, an eight active cell configuration, as shown in FIG. 4C, or a six active cell configuration, as shown in FIG. 4D. The modification of the configuration of reactor system 313 to a low number of active cells will accordingly increase the hydrogen and oxygen production from the reactor system 313 to the ICE 208. Accordingly, the control system 301 may direct the ECU 305 to modify the configuration by de-activating or activating relay elements 304-309.

For example, if the control system 301 determines that the appropriate configuration for reactor system 313 is a ten active cell configuration, the control system 301 directs the ECU 305 to activate the second reactor relay 306. If the first reactor relay 304, third reactor relay 308 or fourth reactor relay 309 is previously activated, then the control system 301 first directs the ECU 305 to de-activate the first, third or fourth reactor relay (as the case may be), and then subsequently instructs the ECU 305 to activate the second reactor relay 306.

Similarly, if the control system 301 determines the appropriate configuration for reactor system 313 is an eight or six active cell configuration, the control system 301 directs the ECU 305 to activate the third reactor relay 308 or fourth reactor relay 309, respectively. If the first reactor relay 304 or the second reactor relay 308 is previously activated, then the control system 301 first directs the ECU 305 to de-activate the first or second reactor relay (as the case may be), and then subsequently directs the ECU 305 to activate the third reactor relay 308 or fourth reactor relay 309.

However, by changing the configuration of the reactor system 313 to a lower active cell configuration, the rate of electrolysis may increase, resulting in increased heat production within the reactor system 313. This may have the effect of increasing the temperature of the reactor system 313. However, if the reactor system 313 is already operating in hot temperatures, reducing the number of active electrolytic cells in the reactor system 313 may not be ideal, since it may have the effect of overheating the reactor system 313. Accordingly, in the illustrated embodiment, the control system 301 also considers the temperature of the reactor system 313 at 1010A before modifying the configuration of the reactor system 313.

For example, if it is determined that the reactor system 313 is already operating at high temperatures (i.e., as determined by the temperature or current sensor), the control system 301 may determine that switching the reactor system 313 to a ten, eight or six active cell configuration will only further increase the temperature of the reactor system 313 (i.e. as a result of increasing the gas production). Accordingly, the control system 301 may determine that maintaining the current cell configuration is appropriate.

At 1014A, once the control system 301 has made an appropriate modification to the configuration of the reactor system (if necessary), the method 1000A ends.

Alternatively, if the control system 301 determines at 1006A that no further supply of hydrogen and oxygen gases is required to be supplied to the ICE 208, the control system 301 then determines at 1006A′ whether the ICE 208 is receiving a surplus of hydrogen and oxygen.

If this is determined to be the case, the control system 301 modifies the configuration for reactor system 313 at 1012A. For example, if the control system 301 determines that the ICE 208 requires a lower input of hydrogen and oxygen, the control system 301 modifies the configuration for reactor system 313 to either a twelve active cell configuration, as shown in FIG. 4A, or a ten active cell configuration, as shown in FIG. 4B. The modification of the configuration of reactor system 313 to have a high number of active cells will decrease the amount of hydrogen and gas delivered by the reactor system 313 to the ICE 208. In particular, the control system 301 may direct the ECU 305 to modify the configuration by de-activating or activating relay elements 304-309 at 908.

For example, if at 1012A, the control system 301 modifies the configuration for reactor system 313 to a ten active cell configuration, the control system 301 directs the ECU 305 to activate the second reactor relay 306. In a case where the first reactor relay 304, third reactor relay 308 or fourth reactor relay 309 is previously activated, the control system 301 first directs the ECU 305 to de-activate the first, third or fourth reactor relay (as the case may be) and then directs the ECU 305 to activate the second reactor relay 306.

Similarly, if at 1012A, the control system 301 determines that the appropriate configuration for the reactor system 313 is a twelve active cell configuration, the control system 301 directs the ECU 305 to activate the first reactor relay 304. If the second reactor relay 306, third reactor relay 308 or fourth reactor relay 309 is previously activated, the control system 301 first directs the ECU 305 to de-activate either the second, third or fourth reactor relay (as the case may be), and then directs the ECU 305 to activate the first reactor relay 304.

If the control system 301 determines that the ICE 208 is not receiving surplus gas at 1006A′, the process returns to 1002 where the control system 301 continues to receive monitoring information from the ECM 206.

Once the control system 301 has made an appropriate modification to the configuration of the reactor system, the process ends at 1014A.

Reference is next made to FIG. 10B, illustrating a further example embodiment for a method 1000B for modifying a configuration of the reactor system 313 according to the hydrogen and oxygen demands of an ICE connected to the reactor system 313. The method 1000B may also be carried out by the control system 301.

In particular, the method 1000B is analogous to the method 1000A of FIG. 10A except that, at 1006B′, if it is determined that more hydrogen and oxygen gas is required to be supplied to the ICE 208, then at 1011B, the control system 301 determines the temperature of the reactor system, and subsequently, at 1012B′, modifies the configuration of the reactor system 313 based additionally on the temperature of the reactor system 313.

As previously mentioned, the control system 301 may determine the ambient temperature of the reactor system 301 using information received from the temperature sensors 355. Alternatively, or in addition, the control system 301 may also determine the relative temperature of the reactor system 301 using current consumption information received, for example, from current sensors 370.

At 1012B′, the control system 301 may then modify the configuration of the reactor system based on both the gas requirements of the ICE 208, as well as the temperature of the reactor system 301. In at least some cases, the control system 301 may determine that, while a higher active cell configuration for the reactor system 301 (e.g. ten active cell or twelve active cell) is required to reduce gas production, the reactor system 301 is already operating at low temperatures. Accordingly, modifying the cell configuration for the reactor system 301 to a higher number of active cells may cause an undesired reduction in the operating temperature of the reactor system 301. In such cases, the control system 301 may determine that the configuration of the reactor system may not be changed at 1012B′.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments

1. A system for modifying a configuration of an electrolytic reactor, the system comprising:
an electrolytic reactor assembly including a plurality of electrolytic cells being arranged in series relative to each other within at least one cell unit, the plurality of electrolytic cells being configured to perform electrolysis on an electrolyte solution, the electrolytic reactor assembly being configured to operate in at least two operation modes;
at least one switching element coupled to at least a predetermined number of cells of the plurality of electrolytic cells in the at least one cell unit, wherein the predetermined number of cells comprises a subset of the plurality of electrolytic cells in the at least one cell unit, the subset being less than a total number of cells in the plurality of electrolytic cells in the at least one cell unit;
a control unit operatively coupled to the at least one switching element and the electrolytic reactor assembly; and
a monitoring system coupled to the control unit, the electrolytic reactor assembly and the at least one switching element, wherein the monitoring system is configured to monitor at least one attribute associated with the electrolytic reactor assembly,
wherein, based on the at least one attribute of the electrolytic reactor assembly monitored by the monitoring system, the control unit is configured to activate the at least one switching element to modify the configuration of the electrolytic reactor assembly between the at least two operation modes, wherein activating the at least one switching element activates the predetermined number of cells in the at least one cell unit.

2. (canceled)

3. (canceled)

4. The system of claim 1, wherein the monitoring system comprises a current sensor configured to monitor a current consumption by the electrolytic reactor assembly, and wherein the control unit is configured to modify the configuration of the electrolytic reactor assembly based on the current consumption by the electrolytic reactor assembly.

5. (canceled)

6. The system of claim 1, wherein the at least one cell unit comprises a first cell unit and a second cell unit, wherein the first cell unit and the second cell unit are arranged in parallel relative to each other, and wherein the electrolytic cells within each of the first cell unit and the second cell unit are arranged in series relative to each other.

7. The system of claim 6, wherein the first cell unit and the second cell unit share a common negative.

8. (canceled)

9. The system of claim 6, wherein the at least one switching element comprises at least one of:
a first switching element coupled to six electrolytic cells in the first cell unit, and six electrolytic cells in the second cell unit,
a second switching element coupled to five electrolytic cells in the first cell unit, and five electrolytic cells in the second cell unit, and
a third switching element coupled to four electrolytic cells in the first cell unit, and four electrolytic cells in the second cell unit.

10. (canceled)

11. The system of claim 9, wherein the control unit is configured to operate the electrolytic reactor assembly in a first operation mode by activating the first switching element based on a first signal from the monitoring system, the first signal indicating that the current consumption of the electrolytic reactor assembly is within a first predetermined current consumption range.

12. (canceled)

13. The system of claim 11, wherein the control unit is configured to operate the electrolytic reactor assembly in a second operation mode by activating the second switching element based on a second signal from the monitoring system, the second signal indicating that the current consumption of the electrolytic reactor assembly is within a second predetermined current consumption range, the second predetermined current consumption range being lower than the first predetermined current consumption range.

14. The system of claim 13, wherein operating the electrolytic reactor assembly in the second operation mode results in the electrolytic reactor system generating more heat than operating the electrolytic reactor assembly in the first operation mode.

15. (canceled)

16. The system of claim 13, wherein the control unit is configured to operate the electrolytic reactor assembly in a third operation mode by activating the third switching element based on a third signal from the monitoring system, the third signal indicating that the current consumption of the electrolytic reactor assembly is within a third predetermined current consumption range, the third predetermined current consumption range being lower than the second predetermined current consumption range.

17. The system of claim 16, wherein operating the electrolytic reactor assembly in the third operation mode results in the electrolytic reactor system generating more heat than operating the electrolytic reactor assembly in either the first operation mode or the second operation mode.

18. (canceled)

19. (canceled)

20. (canceled)

21. The system of claim 1, wherein the monitoring system is further configured to monitor one or more operating conditions of an internal combustion engine, and the control unit is configured to control the at least one switching element based at least on the one or more operating conditions of the internal combustion engine.

22. A method of modifying a configuration of an electrolytic reactor, the electrolytic reactor comprising an electrolytic reactor assembly including a plurality of electrolytic cells being arranged in series relative to each other within at least one cell unit, wherein the electrolytic reactor assembly is configured to perform electrolysis on an electrolyte solution, and operate in at least two operation modes, the method comprising:
determining, by a monitoring system, at least one attribute associated with electrolytic reactor assembly;
analyzing, by a control unit coupled to the monitoring system, the at least one attribute;
determining, by the control unit, an operation mode associated with the electrolytic reactor assembly based on the at least one attribute; and
activating at least one switching element coupled to at least a predetermined number of cells of the plurality of electrolytic cells in the at least one cell unit, the predetermined number of cells comprising a subset of the plurality of electrolytic cells in the at least one cell unit, the subset being less than a total number of cells in the plurality of electrolytic cells in the at least one cell unit, wherein activating the at least one switching element activates the predetermined number of cells in the at least one cell unit to modify the configuration of the electrolytic reactor to the operation mode determined by the control unit.

23. The method of claim 22, further comprising at least one of:
coupling a first switching element to a first predetermined number of electrolytic cells in the electrolytic reactor assembly;
coupling a second switching element to a second predetermined number of electrolytic cells in the electrolytic reactor assembly, the second predetermined number of electrolytic cells being fewer than the first predetermined number of electrolytic cells; and
coupling a third switching element to a third predetermined number of electrolytic cells in the electrolytic reactor assembly, the third predetermined number of electrolytic cells being fewer than the second predetermined number of electrolytic cells.

24. (canceled)

25. The method of claim 23, further comprising:
operating the electrolytic reactor assembly in a first operation mode by activating the first switching element if a first signal from the monitoring system identifies a first predetermined range of current consumption associated with the electrolytic reactor assembly.

26. (canceled)

27. The method of claim 25, further comprising:
operating the electrolytic reactor assembly in a second operation mode by activating the second switching element if a second signal from the monitoring system identifies a second predetermined current consumption range associated with the electrolytic reactor assembly, the second predetermined current consumption range being lower than the first predetermined current consumption range.

28. The method of claim 27, wherein operating the electrolytic reactor assembly in the second operation mode results in the electrolytic reactor system generating more heat than operating the electrolytic reactor assembly in the first operation mode.

29. (canceled)

30. The method of claim 27, further comprising:
operating the electrolytic reactor assembly in a third operation mode by activating the third switching element if a third signal from the monitoring system identifies a third predetermined current consumption range associated with the electrolytic reactor assembly, the third predetermined current consumption range being lower than the second predetermined current consumption range.

31. The method of claim 30, wherein operating the electrolytic reactor assembly in the third operation mode results in the electrolytic reactor system generating more heat than operating the electrolytic reactor assembly in either the first operation mode or the second operation mode.

32. (canceled)

33. (canceled)

34. (canceled)

35. The method of claim 23, wherein the electrolytic reactor is coupled to an internal combustion engine, and the electrolyte solution used in the electrolytic reactor is water, the method further comprising:
detecting one or more operating conditions associated with an internal combustion engine, wherein the internal combustion engine is configured to combust a mixture of a carbon-based fuel, hydrogen gas and oxygen gas;
determining, at the control unit, if the internal combustion engine requires a higher amount of hydrogen gas; and
activating at least one of the second switching element and the third switching element if a higher amount of the hydrogen gas is required by the internal combustion engine.

36. A non-transitory computer-readable medium storing computer-executable instructions, the instructions are executable for causing a processor to perform a method of modifying a configuration of an electrolytic reactor, the electrolytic reactor comprising an electrolytic reactor assembly including a plurality of electrolytic cells being arranged in series relative to each other within at least one cell unit, wherein the electrolytic reactor assembly is configured to perform electrolysis on an electrolyte solution, and operate in at least two operation modes, the method comprising:
determining, by a monitoring system, at least one attribute associated with electrolytic reactor assembly;
analyzing, by a control unit coupled to the monitoring system, the at least one attribute determined by the monitoring system;
determining, by the control unit, an operation mode associated with the electrolytic reactor assembly based on the at least one attribute; and
activating at least one switching element coupled to at least a predetermined number of cells of the plurality of electrolytic cells in the at least one cell unit, the predetermined number of cells comprising a subset of the plurality of electrolytic cells in the at least one cell unit, the subset being less than a total number of cells in the plurality of electrolytic cells in the at least one cell unit, wherein activating the at least one switching elements activates the predetermined number of cells in the at least one cell unit to modify the configuration of the electrolytic reactor to the operation mode determined by the control unit.

37.-49. (canceled)
